(19) United States
(12) Patent Application Publication
(10) Pub. No.: US 2025/0274979 A1
(43) Pub. Date: Aug. 28, 2025

(54) RTS-CTS PROCEDURE FOR EXTENDED RANGE PACKET TRANSMISSION

(71) Applicant: NXP USA, Inc., AUSTIN, TX (US)

(72) Inventors: Priyanka Bansal, Lakheri (IN); Hari Ram Balakrishnan, Chennai (IN); Sudhir Srinivasa, Los Gatos, CA (US)

(21) Appl. No.: 19/006,694

(22) Filed: Dec. 31, 2024

(30) Foreign Application Priority Data
Feb. 28, 2024 (IN) 202441014419
Feb. 28, 2024 (IN) 202441014478

(51) Int. Cl. H04W 74/0816

(52) U.S. Cl. CPC H04W 74/0816

(57) ABSTRACT

Methods and apparatus for wireless channel reservation using extended range Request to Send (RTS)/Clear to Send (CTS) procedures to minimize collisions with OBSS devices. In a method, a first wireless device transmits an extended range RTS frame and receives, in response, a non-extended range CTS frame from a second wireless device. The first wireless device then transmits an extended range physical layer protocol data unit (PPDU) for reception by the second wireless device. This method may further include fragmenting the extended range PPDU into a plurality of extended range fragments, transmitting a first extended range fragment, receiving a non-extended range acknowledgement (ACK) from the second wireless device, and transmitting a second extended range fragment.

### CROSS REFERENCE TO RELATED APPLICATIONS

The present U.S. Utility Patent Application claims priority pursuant to 35 U.S.C. § 119(a) to Indian Provisional Patent Application Serial Number 202441014419, entitled “RTS-CTS PROCEDURE FOR EXTENDED RANGE PACKET TRANSMISSION WITH AP HAVING MORE RANGE THAN STA”, filed Feb. 28, 2024, and Indian Provisional Patent Application Serial Number 202441014478, entitled “RTS-CTS PROCEDURE FOR EXTENDED RANGE PACKET UPLINK TRANSMISSION WITH AP HAVING MORE RANGE THAN STA”, filed Feb. 28, 2024, the contents of both of which are incorporated herein by reference in their entirety and made part of the present U.S. Utility Patent Application for all purposes.

### BACKGROUND

### technical field

This disclosure relates generally to wireless communications, and more specifically to reservation of a transmission channel.

### Description of Related Art

Wireless local area networks (WLANs) have evolved rapidly over the past couple of decades, including WLANs that conform to the Institute of Electrical and Electronics Engineers (IEEE) 802.11 family of standards. A typical 802.11-based WLAN is formed by one or more access points (APs) that provide a shared wireless communication medium for servicing a number of client devices or stations (STAs). In particular, an AP manages a Basic Service Set (BSS) that is identified by a Basic Service Set Identifier (BSSID) and advertised by the AP. The AP periodically broadcasts beacon frames to enable STAs within wireless range of the AP to establish and maintain communication links with the AP.

In such WLANs, wireless devices such as Access Points (APs) and client stations (STAs) wirelessly transmit and receive physical layer protocol data units (PPDUs). As various new services and deployment scenarios are supported by these wireless devices, the devices may need to be able to transmit and receive signals over longer ranges. To extend the range that the PPDUs are transmitted and received, the IEEE 802.11ax and IEEE 802.11be amendments to the IEEE 802.11 standard define an extended range PPDU. The IEEE 802.11b amendment also describes direct sequence spread spectrum (DSSS) communications to support an extended range, but practical applications are limited due to low data rates.

The IEEE 802.11 standard further includes a Request to Send/Clear to Send (RTS/CTS) mechanism intended to reduce frame collisions and manage wireless medium access. In conventional operation, when a STA/AP wants to transmit data, it first sends an RTS frame to the intended recipient. The RTS frame includes information about the duration of the proposed data transmission and any subsequent acknowledgements (ACKs). Upon receiving the RTS frame, the recipient waits for a Short Interframe Space (SIFS) period and then responds with a CTS frame. The CTS frame repeats the duration information, thereby reserving the wireless medium for the specified time. Once the sender receives the CTS frame, it proceeds to send the actual data frames. Other stations in a BSS that overhear the RTS or CTS frames may set their Network Allocation Vector (NAV) timers to defer their transmissions for the duration specified in the RTS/CTS frames.

### BRIEF DESCRIPTION OF THE DRAWINGS

One or more embodiments will now be described by way of example only with reference to the accompanying drawings, in which:

FIG. 1 illustrates an example of a wireless local area network (WLAN) in accordance with embodiments of the present disclosure;

FIG. 2A illustrates an example of a WLAN including an extended range source device communicating with a non-extended range destination device in accordance with embodiments of the present disclosure;

FIG. 2B illustrates an example of a WLAN including a non-extended range source device communicating with an extended range destination device in accordance with embodiments of the present disclosure;

FIG. 3 illustrates a first channel reservation scheme in accordance with an embodiment of the present disclosure;

FIG. 4 illustrates a table presenting a stepwise summarization of the first channel reservation scheme in accordance with an embodiment of the present disclosure;

FIG. 5 illustrates a second channel reservation scheme in accordance with an embodiment of the present disclosure;

FIG. 6 illustrates a table presenting a stepwise summarization of the second channel reservation scheme in accordance with an embodiment of the present disclosure;

FIG. 7 illustrates a third channel reservation scheme in accordance with an embodiment of the present disclosure;

FIG. 8 illustrates a table presenting a stepwise summarization of the third channel reservation scheme in accordance with an embodiment of the present disclosure;

FIG. 9 illustrates a table presenting a stepwise summarization of a variation of the third channel reservation scheme in accordance with an embodiment of the present disclosure;

FIG. 10 illustrates a fourth channel reservation scheme in accordance with an embodiment of the present disclosure;

FIG. 11 illustrates a table presenting a stepwise summarization of the fourth channel reservation scheme in accordance with an embodiment of the present disclosure;

FIG. 12 illustrates a table presenting a stepwise summarization of a variation of the fourth channel reservation scheme in accordance with an embodiment of the present disclosure;

FIG. 13 illustrates a fifth channel reservation scheme in accordance with an embodiment of the present disclosure;

FIG. 14 illustrates a table presenting a stepwise summarization of the fifth channel reservation scheme in accordance with an embodiment of the present disclosure;

FIG. 15 illustrates a table presenting a stepwise summarization of a variation of the fifth channel reservation scheme in accordance with an embodiment of the present disclosure;

FIG. 16 illustrates a sixth channel reservation scheme in accordance with an embodiment of the present disclosure;

FIG. 17 illustrates a table presenting a stepwise summarization of the sixth channel reservation scheme in accordance with an embodiment of the present disclosure;

FIG. 18 illustrates a table presenting a stepwise summarization of a variation of the sixth channel reservation scheme in accordance with an embodiment of the present disclosure;

FIG. 19 is a flow diagram illustrating an example method for channel reservation in accordance with an embodiment of the present disclosure;

FIG. 20 is a flow diagram illustrating another example method for channel reservation in accordance with an embodiment of the present disclosure;

FIG. 21 illustrates an example of an Extended Range (ER)/Enhanced Long Range (ELR) physical layer protocol data unit (PPDU); and

FIG. 22 illustrates an example of non-legacy ELR PPDU.

### DETAILED DESCRIPTION

The various implementations described in the following description relate generally to new and innovative channel reservation schemes applicable to scenarios where a wireless source device(s) and a wireless destination device(s) have differing transmission ranges. More particularly, channel reservation schemes are described for transmissions (e.g., uplink transmissions) between (1) an extended range (ER) source and a non-ER destination and (2) a non-ER source and an ER destination. In various examples, request to send/clear to send (RTS/CTS) mechanisms are described using both ER frames and non-ER frames to reserve a channel for extended range in scenarios wherein there may be asymmetry between the transmission or reception ranges of an AP and a STA. For example, the described channel reservations schemes may include an ER transmitter/source transmitting certain RTS and/or CTS frames in an extended range (ER)/Enhanced Long Range (ELR) physical layer protocol data unit (PPDU) format.

As used herein, the term “non-legacy” may refer to PPDU formats and communication protocols conforming with the IEEE 802.11bn amendment to the IEEE 802.11 standard (also referred to as “802.11bn”, “UHR” or “Wi-Fi 8”) as well as future generations/amendments. In contrast, the term “legacy” may be used herein to refer to PPDU formats and communication protocols conforming to the IEEE 802.11be (also referred to as Extremely High Throughput or “EHT” or “Wi-Fi 7”) or IEEE 802.11ax (also referred to as High Efficiency or “HE” or “Wi-Fi 6/6E”) amendments to the IEEE 802.11 standard, or earlier generations of the IEEE 802.11 standard, but not conforming to all mandatory features of 802.11bn or future generations of the IEEE 802.11 standard. In some implementations, the channel reservation schemes described herein may support multiple versions of the IEEE 802.11 standard.

As used herein, the term ER PPDU refers to an “Extended Range” PPDU (e.g., such as defined by 802.11ax) used to transmit data over longer distances within a standard WLAN, and the term ELR PPDU refers to newer “Extended Long Range” formats designed to achieve even greater range (potentially at the cost of data throughput). The terms “ER PPDU” and “ELR PPDU” are used interchangeably herein unless specifically noted otherwise.

Further, an AP and (associated or unassociated) STA of a described embodiment may each support extended range signaling, but the effective range of one may be greater than the other due to differing implementations of an amendment to the IEEE 802.11 standard (e.g., support for optional features, componentry, etc.) or compliance with differing amendments to the IEEE 802.11 standard (legacy or non-legacy) that define different ER capabilities affording differing extended range capabilities. In such instances, the terms “non-ER AP” and “non-ER STA” as used herein can refer to the AP or STA having a relatively lesser effective range. In addition, the terms “channel”, “transmission channel”, “wireless channel” and “wireless medium” are synonymous and may be used interchangeably herein.

Particular implementations of the subject matter described in the present disclosure can be implemented to realize one or more of the following potential advantages. By providing effective procedures for minimizing collisions and interference in wireless networks involving devices having disparate transmission ranges, the described channel reservation schemes support gains in overall network throughput that will be achievable in accordance with the IEEE 802.11bn amendment of the IEEE 802.11 standard, improvements to the management of time-sensitive traffic (e.g., traffic with bounded low latency), and mitigation of potential interference levels.

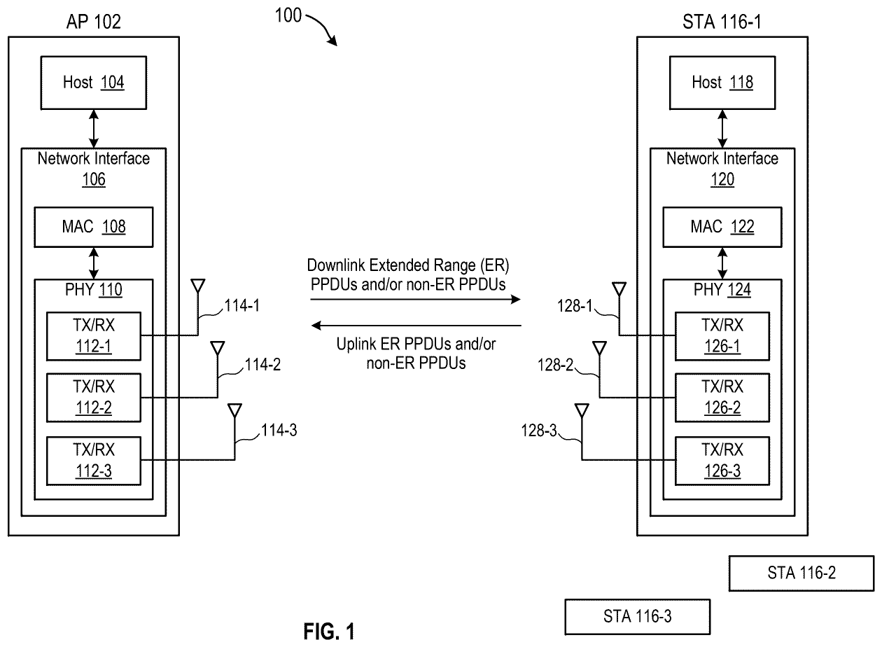

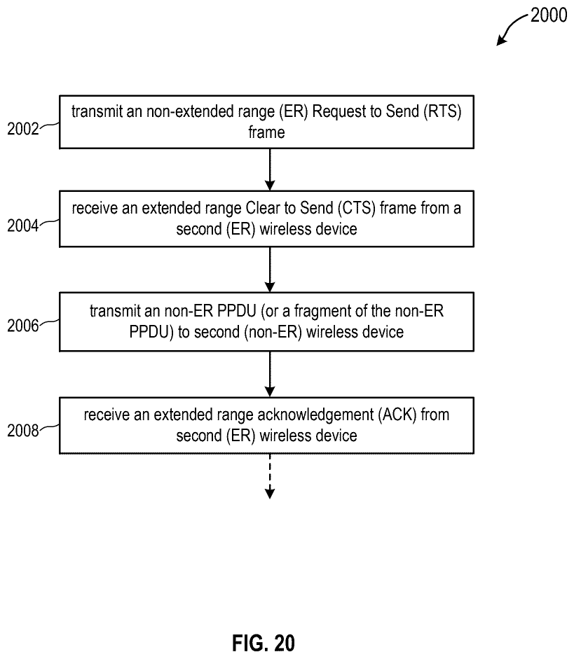

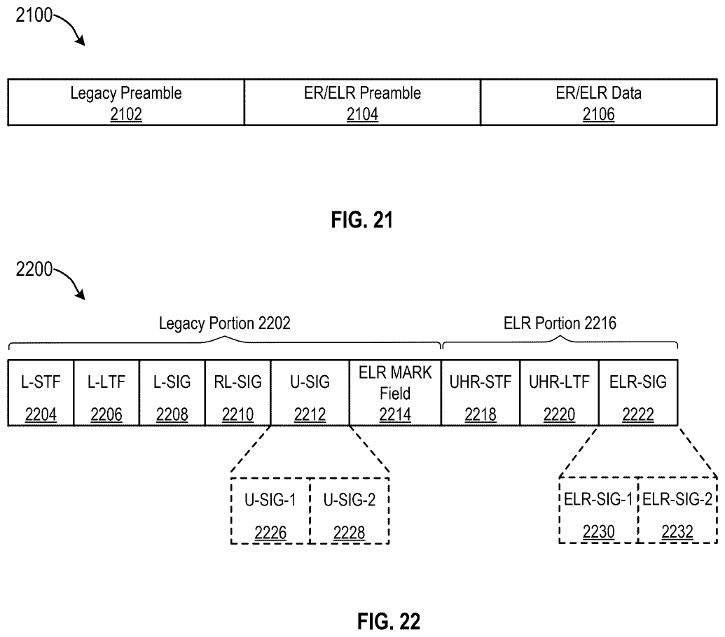

FIG. 1 illustrates an example of a wireless local area network (WLAN) 100 in accordance with embodiments of the present disclosure. The illustrated WLAN includes a wireless access point (AP) 102 and one or more wireless client stations (STAs) 116 (e.g., 116-1, 116-2, and 116-3). The AP102 of this example is configured to transmit downlink Extended Range (ER) and/or non-ER PPDUs and receive uplink ELR PPDUs and/or non-ER PPDUs. The ER PPDUs can have a format and contents such as described in greater detail below with reference to FIG. 21 and FIG. 22.

The illustrated AP 102 includes a host processor 104 coupled to a network interface 106. The network interface 106 includes a medium access control (MAC) processing unit 108 and a physical layer (PHY) processing unit 110. The PHY processing unit 110 includes a plurality of transceivers 112-1, 112-2 and 112-3 (e.g., transmitters and/or receivers) coupled to a respective plurality of antennas 114-1, 114-2 and 114-3. Although three transceivers 112 and three antennas 114 are illustrated in FIG. 1, in other embodiments the AP 102 includes other suitable numbers (e.g., 1, 2, 4, 5, etc.) of transceivers 112 and antennas 114 in other embodiments. In one embodiment, the MAC processing unit 108 and the PHY processing unit 110 are configured to operate in compliance with the IEEE 802.11bn amendment to the IEEE 802.11 standard.

The illustrated WLAN 100 also includes one or more wireless client stations 116. Three client stations 116 shown as 116-1, 116-2, and 116-3 are illustrated in FIG. 1, but the WLAN 100 may include other suitable numbers (e.g., 1, 2, 3, 5, 6, etc.) of client stations 116 in various scenarios and embodiments. At least one of the client stations 116 (e.g., client station 116-1) may be configured to operate in compliance with the IEEE 802.11bn amendment to the IEEE 802.11 standard to communicate with the AP 102.

The client station 116-1 includes a host processor 118 coupled to a network interface 120 which includes a MAC processing unit 122 and a PHY processing unit 124. The PHY processing unit 124 includes a plurality of transceivers 126-1, 126-2 and 126-3, and the transceivers 126 are coupled to a respective plurality of antennas 128-1, 128-2 and 128-3. Although three transceivers 126 and three antennas 128 are illustrated in FIG. 1, the client station 116-1 includes other suitable numbers (e.g., 1, 2, 4, 5, etc.) of transceivers 126 and antennas 128 in other embodiments.

In various embodiments, the PHY processing unit 110 of the AP 102 is configured to generate and transmit (downlink) data units via the antenna(s) 144 over an air interface and the PHY processing unit 124 of the client station 116-1 is configured to receive the (downlink) data units via the antenna(s) 128 over the air interface. Similarly, the PHY processing unit 110 of the client station 116-1 is configured to generate and transmit (extended range and/or non-extended range) data units via the antenna(s) 128 and the PHY processing unit 110 of the AP 102 is configured to receive the (uplink) data units via the antenna(s) 124. In an example, the data units may be physical layer data units (PPDUs) for communicating data between the AP 102 and the client station 116-1 and the PPDUs (and fields therein) may be transmitted as a waveform in a downlink or uplink direction.

In embodiments, the network interface 106 of the AP 102 and the network interface 120 of one or more of the client stations 116 are configured to generate, transmit and receive ER/ELR PPDUs having an extended range format to increase a range and/or a signal-to-noise (SNR) ratio associated with transmitting, receiving, and successfully decoding the ER/ELR PPDUs exchanged in the WLAN 100. In an example, the ELR PPDUs are compliant with the IEEE 802.11bn (or later) amendment to the IEEE 802.11 standard, and include a legacy portion with legacy fields of one or more legacy IEEE 802.11 standards for backwards compatibility with legacy devices and an extended range (ER) portion with non-legacy fields of a non-legacy IEEE 802.11 standard which can be decoded by non-legacy devices. In an example, various of the fields of an ER PPDU are repeated in a time domain and/or duplicated in a frequency domain to increase a range and/or SNR associated with transmission and reception of data in the ER portion of the ER PPDUs. In another example, the ER PPDU may be a trigger frame which is transmitted by the AP device 102 and which is received by the client station 116 in a downlink direction.

The range extension features of the ER PPDU may allow a client station 116 to decode the ER portion of the ER PPDU at an extended range. Decoding is a process of determining a valid pattern of bits of the received ER PPDU referred to as decoded bits. In an example, the decoding may involve performing a parity check or CRC which determines whether the decoding is successful or is not successful. A downlink ER PPDU transmitted by AP 102 may solicit a response from a client station 116 in the form of an uplink ER PPDU or a non-ER PPDU.

In an embodiment, when operating in single-user mode, the AP 102 transmits a data unit to a single client station (DL SU transmission), or receives a data unit transmitted by a single client station (UL SU transmission), without simultaneous transmission to, or by, any other client station. When operating in multi-user mode, the AP 102 transmits a data unit that includes multiple data streams for multiple client stations (DL MU transmission), or receives data units simultaneously transmitted by multiple client stations (UL MU transmission). For example, in multi-user mode, a data unit transmitted by the MLD includes multiple data streams simultaneously transmitted by the AP 102 to respective client stations using respective spatial streams allocated for simultaneous transmission to the respective client stations and/or using respective sets of OFDM tones corresponding to respective frequency sub-channels allocated for simultaneous transmission to the respective client stations. In a further example, the AP 102 and/or client station(s) 116 may be configured as a multi-link device (MLD). In another example, the AP 102 and/or one or more of the client stations 116 are configured to transmit and receive PPDUs over a plurality of wireless links, including one or more of a 2.4 Gigahertz (GHz) link, a 5 GHz link, a 6 GHz link, and a mmWave link (e.g., a 45 GHz link and/or a 60 GHz link).

In an example, the illustrated AP 102 may be connected to a distribution system (DS) through a distribution system medium (DSM). The distribution system may be a wired network or a wireless network that is connected to a backbone network such as the Internet. The DSM may be a wired medium (e.g., Ethernet cables, telephone network cables, or fiber optic cables) or a wireless medium (e.g., infrared, broadcast radio, cellular radio, or microwaves). Although some examples of the DSM are described, the DSM is not limited to the examples described herein. In another example, the AP 102 and/or client stations 116 may be implemented in a laptop, a desktop personal computer (PC), a mobile phone, or other communications device that supports at least one WLAN communications standard (e.g., at least one IEEE 802.11 standard).

In an example, one or more of the AP 102 and client stations 116 may be implemented with circuitry such as one or more of analog circuitry, mixed signal circuitry, memory circuitry, logic circuitry, and processing circuitry that executes code stored in a memory that when executed by the processing circuitry performs the disclosed functions. For example, the AP 102 and client stations 116 may include memory storing operational instructions (software, program instructions, computer instructions, etc.) and one or more processing modules/processors, operably coupled to one or more wireless transceivers and the memory, configured to execute the operational to perform the described channel reservation schemes.

In another example, a network interface 106/120 includes one or more integrated circuit (IC) devices. In this example, at least some of the functionality of a MAC processing unit 108/122 and at least some of the functionality of the PHY processing unit 110 can be implemented on a single IC device. As another example, at least some of the functionality of the MAC processing unit 108 is implemented on a first IC device, and at least some of the functionality of the PHY processing unit 110 is implemented on a second IC device.

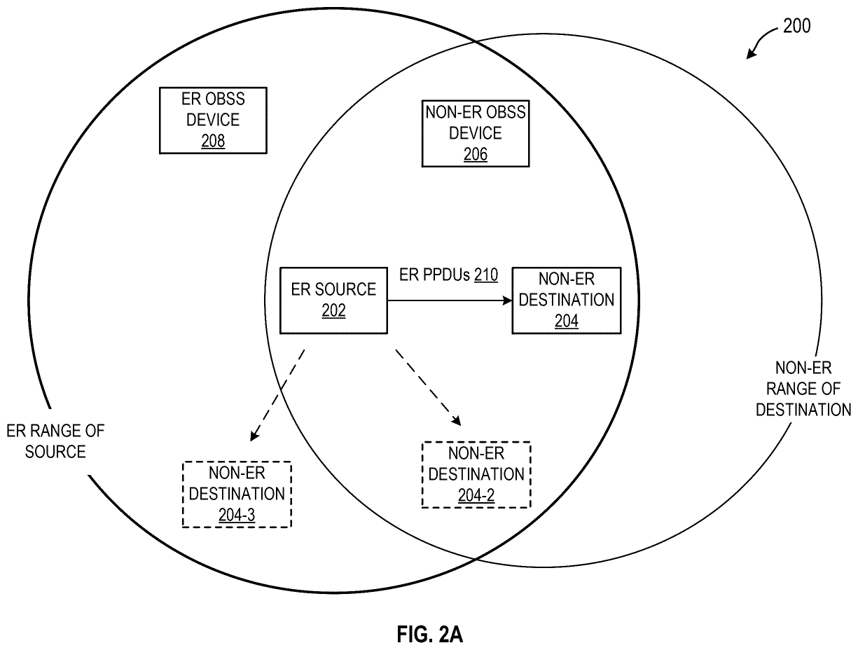

FIG. 2A illustrates an example of a WLAN 200 including an extended range (ER) source 202 (e.g., a STA) communicating with a non-extended range (non-ER) destination(s) 204 (e.g., an AP) in accordance with embodiments of the present disclosure. In the illustrated example, the WLAN 200 further includes a non-ER OBSS (Overlapping BSS) device 206 and an ER OBSS device 208 which may utilize one or more of the same transmission channels as the ER source 202 and non-ER destination 204. One or more of the ER source 202, non-ER destination(s) 204, non-ER OBSS device 206 and ER OBSS device 208 may be an example of an AP 102 or STA 116 of FIG. 1.

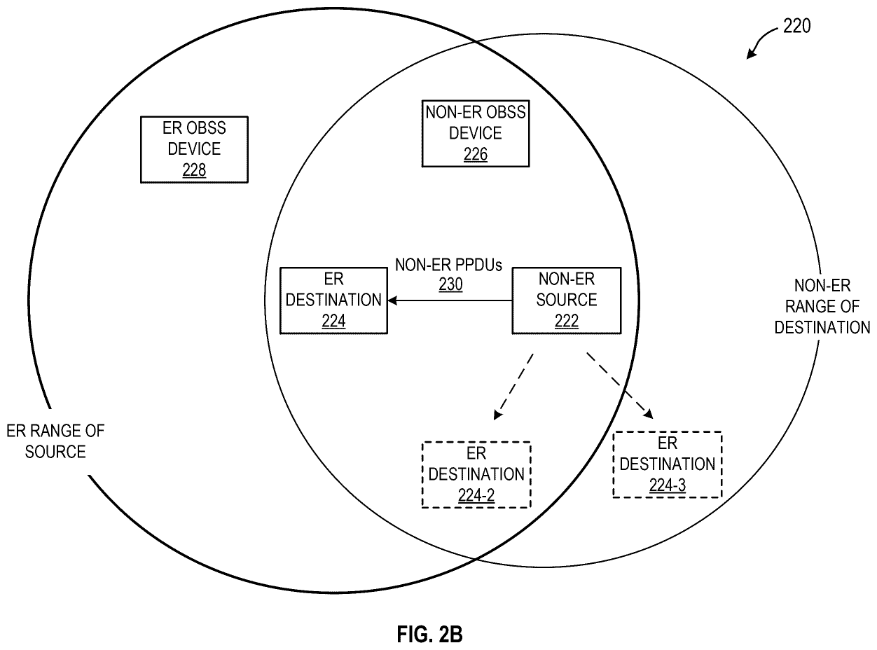

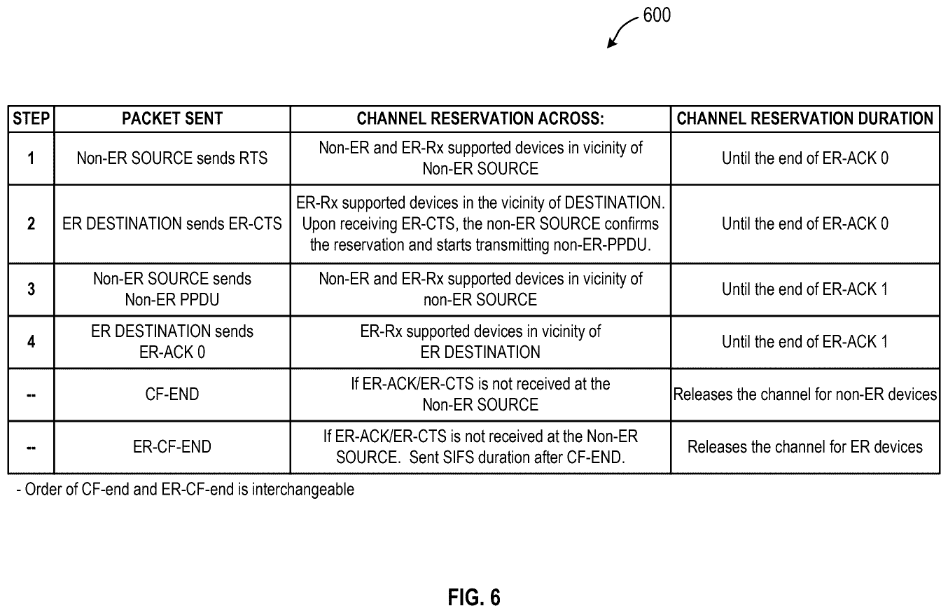

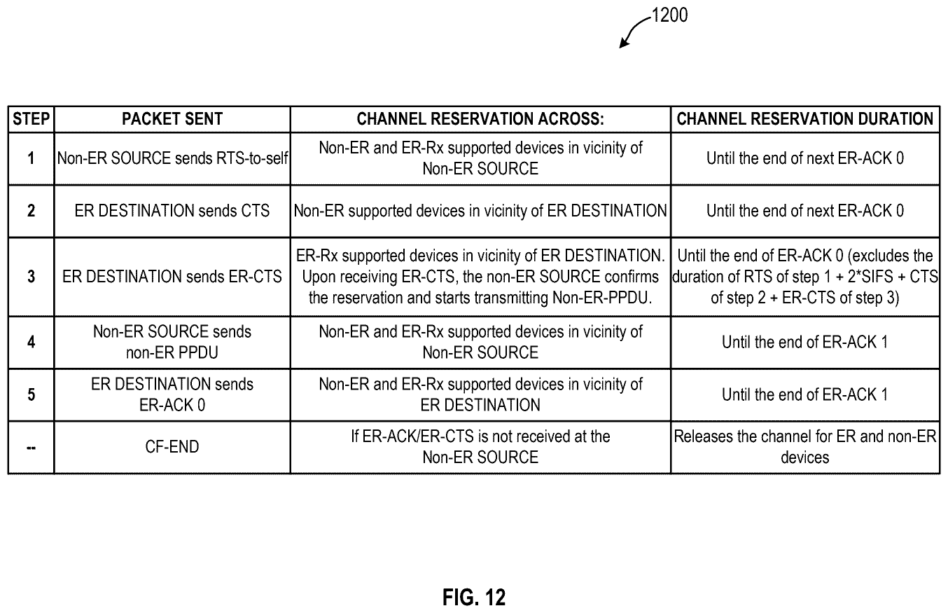

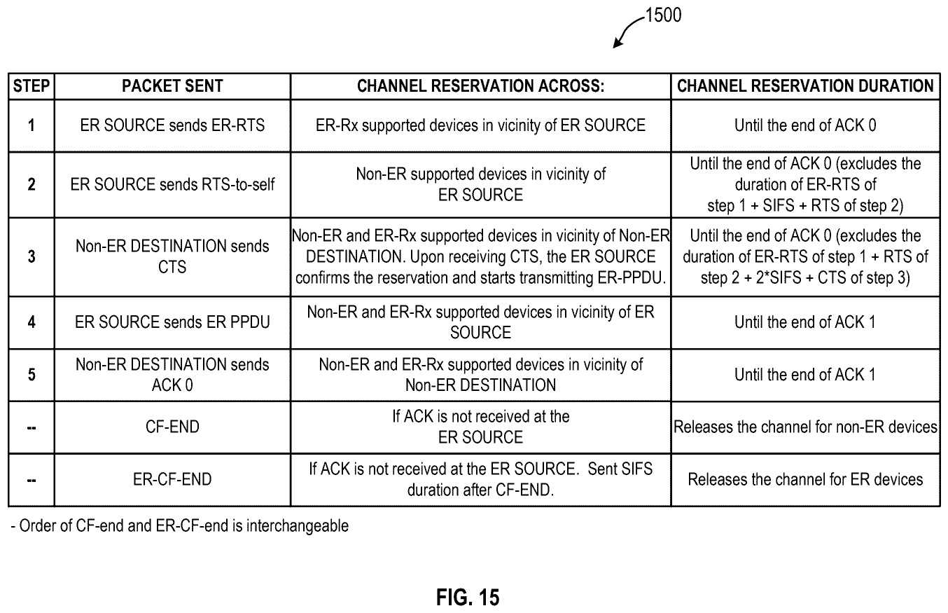

In the illustrated example, the ER source 202 may transmit ER PPDUs 210 to the non-ER destination 204. In this example, one or more non-ER OBSS devices 206 are located within the non-ER range of the non-ER destination(s) 204, one or more ER OBSS devices 208 and the ER destination(s) 204 are located within the ER range of the ER source 202, and the ER source 202 is located within the non-ER range of the ER destination 204. In the topology of the depicted WLAN 200, the ER source 202, the ER destination 204, the non-ER OBSS device 206, and the ER OBSS device 208 may correspond to the similarly labeled devices illustrated in channel reservation schemes of FIG. 3, FIG. 7, FIG. 13, and FIG. 16.

FIG. 2B illustrates an example of a WLAN 220 including a non-ER source 222 (e.g., an AP) communicating with an ER destination(s) 224 (e.g., a STA(s)) in accordance with embodiments of the present disclosure. In the illustrated example, the WLAN 220 further includes a non-ER OBSS device 226 and an ER OBSS device 228 which may utilize one or more of the same transmission channels as the non-ER source 222 and ER destination 224. One or more of the non-ER source 222, ER destination(s) 224, non-ER OBSS device 226 and ER OBSS device 228 may be an example of an AP 102 or STA 116 of FIG. 1.

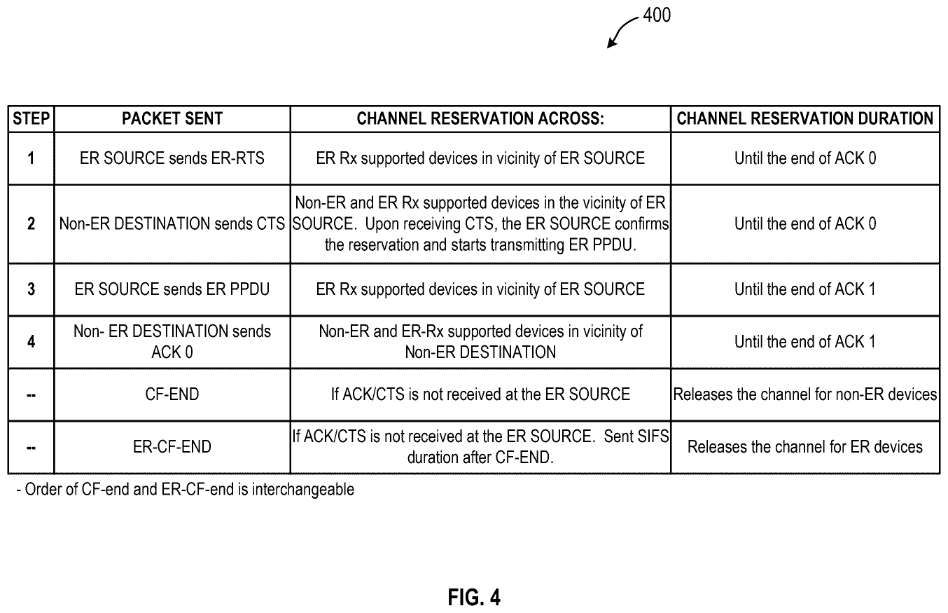

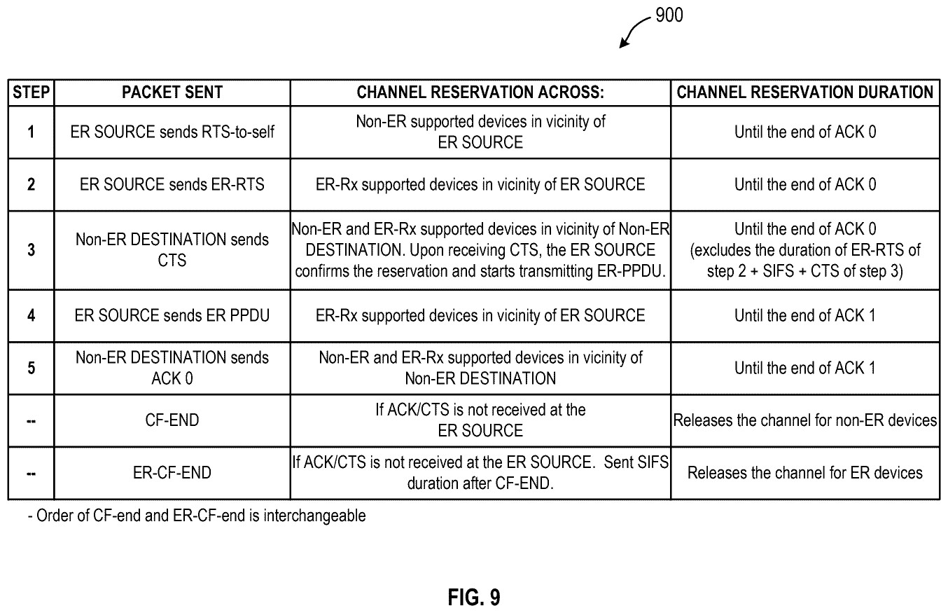

In the illustrated example, the non-ER source 222 may transmit non-ER PPDUs 230 to the ER destination 224. In this example, the non-ER OBSS device 226 and the ER OBSS device 228 are located within the non-ER range of the non-ER source 222, the non-ER OBSS device 226 and the ER OBSS device 228 are located within the ER range of the ER destination 224, and the ER destination 224 is located within the non-ER range of the ER source 222. In the topology of the depicted WLAN 220, the non-ER source 222, the ER destination 224, the non-ER OBSS device 226, and the ER OBSS device 228 may correspond to the similarly labeled devices illustrated in channel reservation schemes of FIG. 5 and FIG. 10.

FIGS. 3-18 illustrate various channel reservation schemes in which RTS/CTS frames are exchanged using a combination of using both ER packets/frames and non-ER packets/frames to reserve a channel for extended range in scenarios wherein there may be asymmetry between the transmission or reception ranges of a source device and destination device. In various of the Figures, operation of Network Allocation Vector (NAV) timers is illustrated. Briefly, a NAV is a virtual carrier-sensing mechanism used in wireless networking protocols such as IEEE 802.11 to help manage access to a wireless medium/transmission channel. In operation, a NAV functions as a timer to indicate the duration for which a transmission channel will be occupied. In an example, when a STA receives a frame addressed to another device, it decodes a duration field in the frame header which specifics a time (e.g., in microseconds) transmission and any subsequent acknowledgements. The STA then sets a NAV timer to this value, during which it refrains from attempting to access the transmission channel. A STA/AP may maintain multiple NAV timers, including a NAV timer(s) that handles channel reservations for frames received from an Overlapping BSS (OBSS) that utilizes the same transmission channel.

FIG. 3 illustrates a first channel reservation scheme 300 in accordance with an embodiment of the present disclosure. In this example, an extended range (ER) source 302 may be required to communicate with a non-ER destination 304. To facilitate such communication between the ER source 302 and the non-ER destination 304, a transmission channel between the two devices may be reserved. When the transmission channel is reserved for the ER source 302 and the non-ER destination 304, other devices within range may perceive the transmission channel as unavailable for use.

In the first channel reservation scheme 300, the ER source transmits an extended range Request-to-Send (ER-RTS) frame 310 to non-ER destination 304. The ER-RTS frame 310 contains a source address, a destination address, and a transaction duration. The transaction duration may indicate, for example, a time required for completion of the all of the related transactions between the ER source 302 and the non-ER destination 304. In the illustrated example, an ER OBSS device 306 detects the ER-RTS frame 310 and sets or updates a corresponding NAV timer (or “NAV”) NAV (ER-RTS) 316 to reflect the transaction duration indicated by the ER-RTS frame 310. In response to the ER-RTS frame 310, the non-ER destination 304 is configured to transmit a Clear-to-Send (CTS) frame 312. The CTS frame 312 may include the address of the ER source 302 and a transaction duration based on the ER-RTS frame duration (e.g., such that it covers the reservation as per the ER-RTS duration). In this example, the ER OBSS device(s) 306 and non-ER OBSS device(s) 308 (e.g., devices in vicinity of the ER source 302) detect the CTS frame and update respective NAV timers NAV (CTS) 318 and NAV (CTS) 320.

Upon receiving the CTS frame 312 from the non-ER destination 304, the ER source 302 may determine that the transmission channel is reserved and transmit an ER PPDU to the non-ER destination 304 in ‘n+1’ fragments 314-0, . . . , 314-n, where n is a positive integer. Based on the reception of each of the n+1 fragments of the ER-PPDU frame, the non-ER destination 304 may be configured to transmit ‘n+1’ acknowledgements (ACKs) 316-0, . . . , 316-n (also referred to as ACK0) for the n+1 fragments of the ER-PPDU frame. For example, based on receiving an ER-PPDU fragment 1, ACK1 is transmitted by the non-ER destination 304. In the illustrated example, the ER OBSS device 306 is further configured to update NAV (ER-fragment i) 322 corresponding to channel reservation based on the duration indicated in ER-PPDU (fragment i), which may include an ACK duration. In addition, the ER OBSS device 306 and the non-ER OBSS device 308 are further configured to update a respective NAV (ACK i) 324 and 326 corresponding to channel reservation based on the duration indicated by each ACK i 316.

In a further example, the ER source 302 may not receive the CTS frame 312 or an ACK 316. In such a scenario, the ER source 302 may be configured to wait for a time duration (e.g., short inter-frame spacing (SIFS)*2+ACK/CTS+slot time) and then transmit a contention-free end (CF-END) frame or ER-CF-END frame to the non-ER destination 304 in order to release the transmission channel. In another example, the non-ER destination 304 may not receive an ER-PPDU fragment for a pre-defined time duration or may receive a CF-END frame from the ER source 302. In such a scenario, the non-ER destination 304 may transmit a CF-END frame to the ER source 302. In a further example, the ordering of the CF-END frames is reversed.

Frame collisions may result due to the conventional RTS/CTS mechanism's inability to guarantee a transmission channel reservation at longer ranges. For example, non-ER devices which cannot operate in the ER range may detect the channel as free even if ER transmissions are ongoing, which may result in frame collisions. By reserving the channel for extended range using the first channel reservation scheme 300 (or any of the following channel reservations schemes) to reserve the channel for extended range, the possibility of frame collisions caused by hidden nodes can be mitigated.

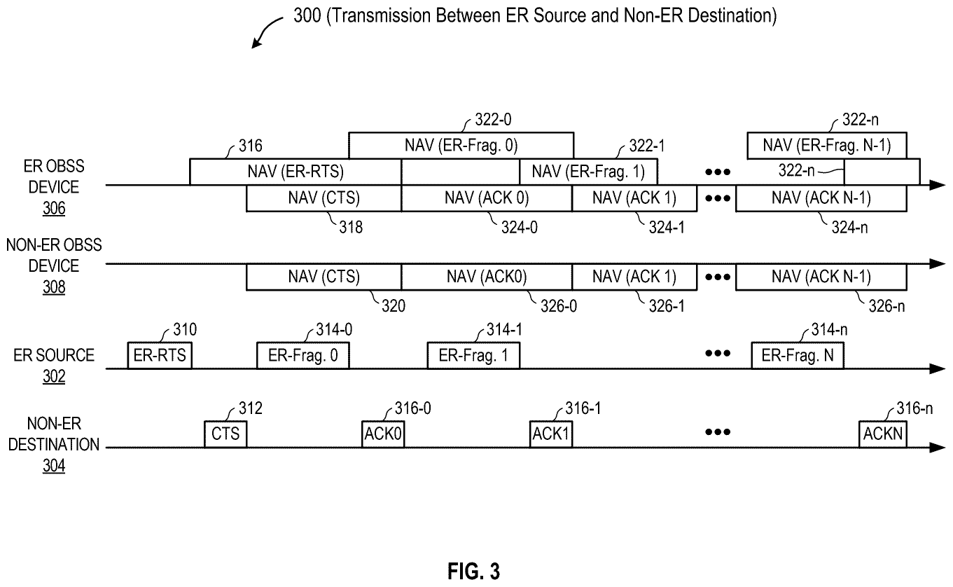

FIG. 4 illustrates a table 400 presenting a stepwise summarization of the first channel reservation scheme 300 in accordance with an embodiment of the present disclosure. More particularly, the table 400 illustrates: (1) a transmitted packet/frame and the device transmitting the packet (e.g., ER source, non-ER source, ER destination or non-ER destination); (2) the function of the transmitted packet (e.g., channel reservations); and (3) a channel reservation duration based on each packet for the first channel reservation scheme 300 described above with reference to FIG. 3. Each row of the table corresponds to one step.

FIG. 5 illustrates a second channel reservation scheme 500 in accordance with an embodiment of the present disclosure. In this example, a non-extended range (non-ER) source 502 may be required to communicate with an ER destination 504. To facilitate such communication between the non-ER source 502 and the ER destination 504, a transmission channel between the two devices may be reserved. When the transmission channel is reserved for the non-ER source 502 and the ER destination 504, other devices within range may perceive the transmission channel as unavailable for use.

In the second channel reservation scheme 500, the non-ER source 502 transmits a Request-to-Send (RTS) frame 510 to ER destination 504. The RTS frame 510 contains a source address, a destination address, and a transaction duration. The transaction duration may indicate, for example, a time required for completion of the all of the related transactions between the non-ER source 502 and the ER destination 504. In the illustrated example, an ER OBSS device(s) 506 and the non-ER OBSS device(s) 508 detect the RTS frame 510 and update a respective NAV (RTS) 518 and 516 to reflect the transaction duration indicated by the RTS frame 510. In response to the RTS frame 510, the ER destination 504 is configured to transmit an extended range Clear-to-Send (ER-CTS) frame. The ER-CTS frame may include the address of the non-ER source 502 and a transaction duration based on the RTS frame duration (e.g., such that it covers the reservation as per the RTS duration). In this example, the non-ER OBSS device(s) 508 (e.g., devices in vicinity of the non-ER source 502) detect the ER-CTS frame and updates NAV (ER-CTS) 520.

Upon receiving the ER-CTS frame 512 from the ER destination 504, the non-ER source 502 may determine that the transmission channel is reserved and transmit a PPDU to the ER destination 504 in ‘n+1’ fragments 514-0, . . . , 514-n, where n is a positive integer. Based on the reception of each of the n+1 fragments of the PPDU frame, the ER destination 504 may be configured to transmit ‘n+1’ extended range acknowledgements (ER-ACKs) 516-0, . . . , 516-n (also referred to as ER-ACK0-ER-ACKN) for the n+1 fragments of the ER-PPDU frame. For example, based on receiving a PPDU fragment 1, ER-ACK1 is transmitted by the ER destination 504. In the illustrated example, the ER OBSS device 506 and the non-ER OBSS 508 are further configured to update a respective NAV (fragment i) 522 and 524 corresponding to channel reservation based on the duration indicated in PPDU (fragment i), which may include an ER-ACK duration. In addition, the non-ER OBSS device 508 is further configured to update a NAV (ER-ACK i) 526 corresponding to channel reservation based on the duration indicated by each ER-ACK i 516.

In a further example, the non-ER source 502 may not receive the ER-CTS frame 512 or an ER-ACK 516. In such a scenario, the non-ER source 502 may be configured to wait for a time duration (e.g., short inter-frame spacing (SIFS)*2+ACK/CTS+slot time) and then transmit a contention-free end (CF-END) frame in order to release the transmission channel. In another example, the ER destination 504 may not receive a PPDU fragment for a pre-defined time duration or may receive a CF-END frame from the non-ER source 502. In such a scenario, the ER destination 504 may transmit a CF-END/ER-CF-END frame to the non-ER source 502. In a further example, the ordering of the CF-END frames is reversed.

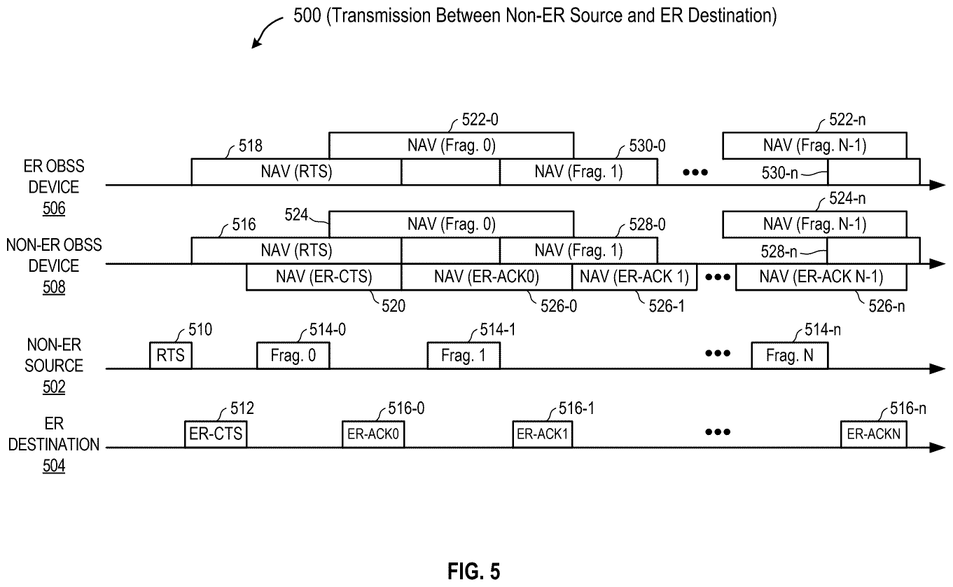

FIG. 6 illustrates a table 600 presenting a stepwise summarization of the second channel reservation scheme 500 in accordance with an embodiment of the present disclosure. More particularly, the table 600 illustrates: (1) a transmitted packet/frame and the device transmitting the packet (e.g., ER source, non-ER source, ER destination or non-ER destination); (2) the function of the transmitted packet (e.g., channel reservations); and (3) a channel reservation duration based on each packet for the second channel reservation scheme 500 described above with reference to FIG. 5. Each row of the table corresponds to one step.

FIG. 7 illustrates a third channel reservation scheme 700 in accordance with an embodiment of the present disclosure. In this example, an extended range (ER) source 702 may be required to communicate with a non-ER destination 704. To facilitate such communication between the ER source 702 and the non-ER destination 704, a transmission channel between the two devices may be reserved. When the transmission channel is reserved for the ER source 702 and the non-ER destination 704, other devices within range may perceive the transmission channel as unavailable for use.

In the third channel reservation scheme 700, the ER source transmits a Request-to-Send (RTS) frame 710 to non-ER destination 704, followed by an extended range Request-to-Send (ER-RTS) frame 712. Each of the RTS frame 710 and the ER-RTS frame 712 contains a source address, a destination address, and a transaction duration. The transaction duration may indicate, for example, a time required for completion of the all of the related transactions between the ER source 702 and the non-ER destination 704. In the illustrated example, a non-ER OBSS device 708 detects the RTS frame 710 and updates a corresponding NAV (RTS) 724 to reflect the transaction duration indicated by the RTS frame 710, and an ER OBSS device 706 detects the ER-RTS frame 712 and sets or updates a corresponding NAV (ER-RTS) 726 to reflect the transaction duration indicated by the ER-RTS frame 712. In response to the ER-RTS frame 712, the non-ER destination 704 is configured to transmit a Clear-to-Send (CTS) frame 714. The CTS frame 714 may include the address of the ER source 702 and a transaction duration based on the ER-RTS frame duration (e.g., such that it covers the reservation as per the ER-RTS duration). In this example, the ER OBSS device 706 and non-ER OBSS device 708 (e.g., devices in vicinity of the ER source 702) detect the CTS frame 714 and update respective NAV timers NAV (CTS) 730 and NAV (CTS) 728.

Upon receiving the CTS frame 712 from the non-ER destination 704, the ER source 702 may determine that the transmission channel is reserved and transmit an ER PPDU to the non-ER destination 704 in ‘n+1’ fragments 716-0, . . . , 716-n, where n is a positive integer. Based on the reception of each of the n+1 fragments of the ER-PPDU frame, the non-ER destination 704 may be configured to transmit ‘n+1’ acknowledgements (ACKs) 718-0, . . . , 718-n (also referred to as ACK0) for the n+1 fragments of the ER-PPDU frame. For example, based on receiving an ER-PPDU fragment 1, ACK1 is transmitted by the non-ER destination 704. In the illustrated example, the ER OBSS device 706 is further configured to update NAV (ER-fragment i) 732 corresponding to channel reservation based on the duration indicated in ER-PPDU (fragment i), which may include an ACK duration. In addition, the ER OBSS device 706 and the non-ER OBSS device 708 are further configured to update a respective NAV (ACK i) 734 and 736 corresponding to channel reservation based on the duration indicated by each ACK i 718. In this example, the ER source 702 is further configured to transmit a CTS frame 720 (e.g., a CTS-to-self frame) following receipt of an ACK. In response, the non-ER OBSS device 708 updates a NAV (CTS) 738.

In a further example, the ER source 702 may not receive the CTS frame 714 or an ACK 718. In such a scenario, the ER source 702 may be configured to wait for a time duration (e.g., short inter-frame spacing (SIFS)*2+ACK/CTS+slot time) and then transmit a contention-free end (CF-END) frame or ER-CF-END frame to the non-ER destination 704 in order to release the transmission channel. In another example, the non-ER destination 704 may not receive an ER-PPDU fragment for a pre-defined time duration or may receive a CF-END frame from the ER source 702. In such a scenario, the non-ER destination 704 may transmit a CF-END frame to the ER source 702. In a further example, the ordering of the CF-END frames is reversed.

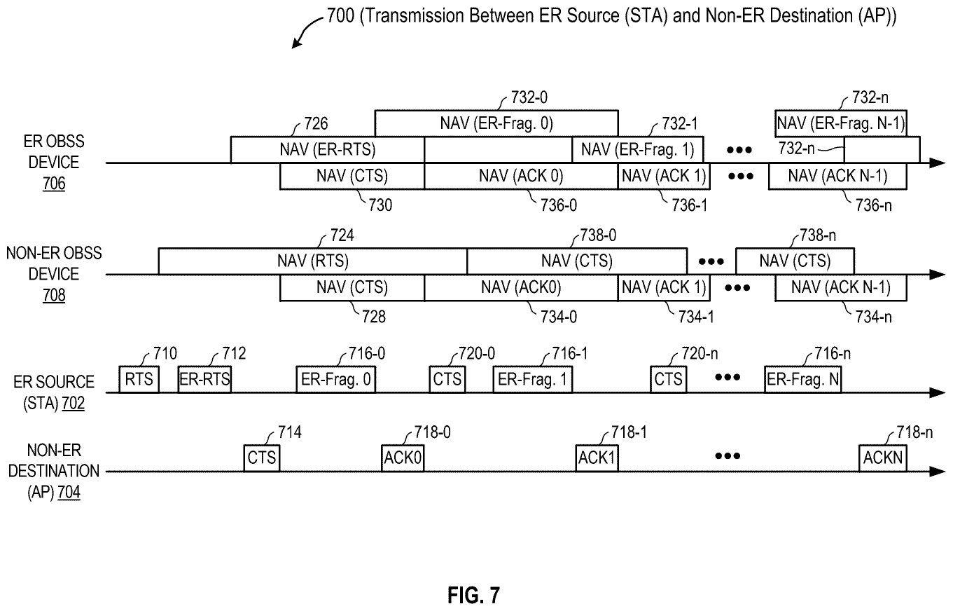

FIG. 8 illustrates a table 800 presenting a stepwise summarization of the third channel reservation scheme 700 in accordance with an embodiment of the present disclosure. More particularly, the table 800 illustrates: (1) a transmitted packet/frame and the device transmitting the packet (e.g., ER source, non-ER source, ER destination or non-ER destination); (2) the function of the transmitted packet (e.g., channel reservations); and (3) a channel reservation duration based on each packet for the first channel reservation scheme 700 described above with reference to FIG. 7. Each row of the table corresponds to one step.

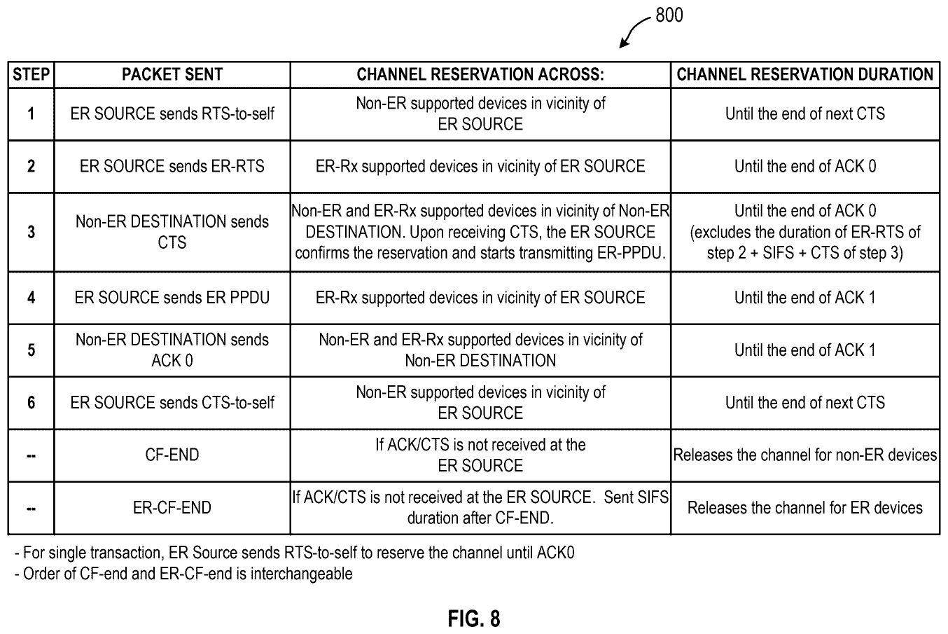

FIG. 9 illustrates a table 900 presenting a stepwise summarization of a variation of the third channel reservation scheme 700 in accordance with an embodiment of the present disclosure. More particularly, the table 900 illustrates: (1) a transmitted packet/frame and the device transmitting the packet (e.g., ER source, non-ER source, ER destination or non-ER destination); (2) the function of the transmitted packet (e.g., channel reservations); and (3) a channel reservation duration based on each packet for the third channel reservation scheme 700 described above with reference to FIG. 7, with the exception that in this variation the ER source 702 does not transmit a CTS-to-self frame after transmitting an ER fragment. Each row of the table corresponds to one step.

FIG. 10 illustrates a fourth channel reservation scheme 1000 in accordance with an embodiment of the present disclosure. In this example, a non-extended range (ER) source 1002 may be required to communicate with an ER destination 1004. To facilitate such communication between the non-ER source 1002 and the ER destination 1004, a transmission channel between the two devices may be reserved. When the transmission channel is reserved for the non-ER source 1002 and the ER destination 1004, other devices within range may perceive the transmission channel as unavailable for use.

In the fourth channel reservation scheme 1000, the non-ER source 1002 transmits a Request-to-Send (RTS) frame 1010 to ER destination 1004, the RTS frame 1010 containing a source address, a destination address, and a transaction duration. The transaction duration may indicate, for example, a time required for completion of the all of the related transactions between the non-ER source 1002 and the ER destination 1004. In the illustrated example, an ER OBSS device 1006 and a non-ER OBSS device 1008 detect the RTS frame 1010 and update a corresponding NAV (RTS) 1022 and 1024 to reflect the transaction duration indicated by the RTS frame 1010. In response to the RTS frame 1010, the ER destination 1004 is configured to transmit a Clear-to-Send (CTS) frame 1012 followed by an ER-CTS frame 1014. Each of the CTS frame 1012 and CTS frame 1014 may include the address of the non-ER source 1002 and a transaction duration based on the RTS frame duration (e.g., such that it covers the reservation as per the RTS duration). In this example, the ER OBSS device 1006 and non-ER OBSS device 1008 (e.g., devices in vicinity of the non-ER source 1002) detect the CTS frame 1012 and update respective NAV timers NAV (CTS) 1026 and NAV (CTS) 1028. In addition, the ER OBSS device 1006 detects the ER-CTS frame 1014 and updates NAV (ER-CTS) 1026 to reflect the transaction duration indicated by the ER-CTS frame 1014.

Upon receiving the ER-CTS frame 1014 from the ER destination 1004, the non-ER source 1002 may determine that the transmission channel is reserved and transmit a PPDU to the ER destination 1004 in ‘n+1’ fragments 1016-0, . . . , 1016-n, where n is a positive integer. Based on the reception of each of the n+1 fragments of the PPDU frame, the ER destination 1004 may be configured to transmit ‘n+1’ extended range acknowledgements (ER-ACKs) 1018-0, . . . , 1018-n (also referred to as ER-ACK0-ER-ACKN) for the n+1 fragments of the PPDU frame. For example, based on receiving an PPDU fragment 1, ACK1 is transmitted by the ER destination 1004. In the illustrated example, the ER OBSS device 1006 is further configured to update NAV (fragment i) 1030 corresponding to channel reservation based on the duration indicated in PPDU (fragment i), which may include an ACK duration. In addition, the ER OBSS device 1006 is further configured to update a NAV (ACK i) 1036 corresponding to channel reservation based on the duration indicated by each ACK i 1018. In this example, the ER destination 1004 is further configured to transmit a CTS frame 1020 (e.g., a CTS-to-self frame) following receipt of an ACK. In response, the non-ER OBSS device 1008 updates a NAV (CTS) 1034.

In a further example, the non-ER source 1002 may not receive the CTS frame 1012 or an ER-ACK 1018. In such a scenario, the non-ER source 1002 may be configured to wait for a time duration (e.g., short inter-frame spacing (SIFS)*2+ACK/CTS+slot time) and then transmit a contention-free end (CF-END) frame to the ER destination 1004 in order to release the transmission channel. In another example, the ER destination 1004 may not receive an PPDU fragment for a pre-defined time duration or may receive a CF-END frame from the non-ER source 1002. In such a scenario, the ER destination 1004 may transmit a CF-END frame to the non-ER source 1002. In a further example, the ordering of the CF-END frames is reversed.

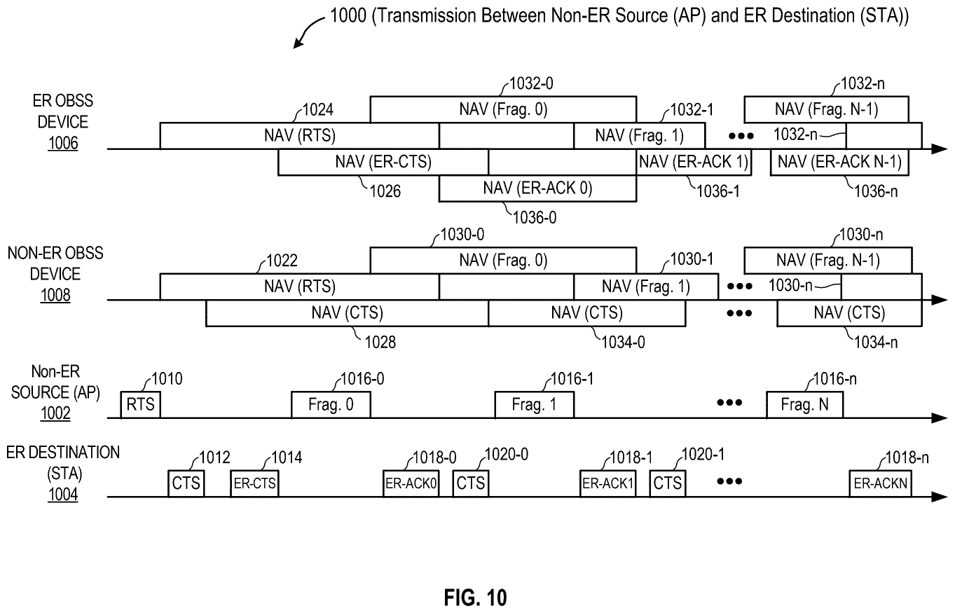

FIG. 11 illustrates a table 1100 presenting a stepwise summarization of the fourth channel reservation scheme 1000 in accordance with an embodiment of the present disclosure. More particularly, the table 1100 illustrates: (1) a transmitted packet/frame and the device transmitting the packet (e.g., ER source, non-ER source, ER destination or non-ER destination); (2) the function of the transmitted packet (e.g., channel reservations); and (3) a channel reservation duration based on each packet for the fourth channel reservation scheme 1000 described above with reference to FIG. 10. Each row of the table corresponds to one step.

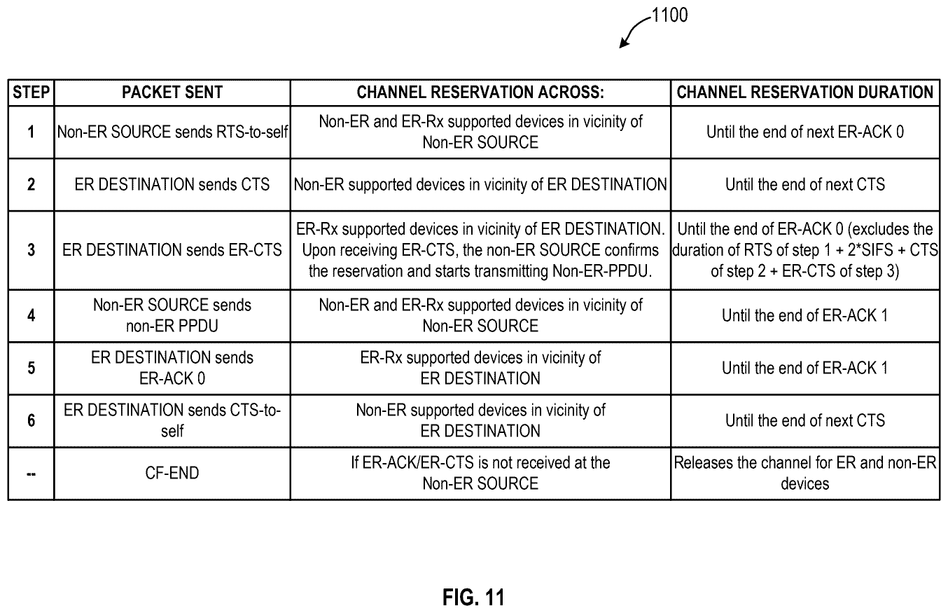

FIG. 12 illustrates a table 1200 presenting a stepwise summarization of a variation of the fourth channel reservation scheme 1000 in accordance with an embodiment of the present disclosure. More particularly, the table 1200 illustrates: (1) a transmitted packet/frame and the device transmitting the packet (e.g., ER source, non-ER source, ER destination or non-ER destination); (2) the function of the transmitted packet (e.g., channel reservations); and (3) a channel reservation duration based on each packet for the fourth channel reservation scheme 1000 described above with reference to FIG. 10, with the exception that in this variation the ER destination 1004 does not transmit a CTS-to-self frame after transmitting an ER-ACK. Each row of the table corresponds to one step.

FIG. 13 illustrates a fifth channel reservation scheme 1300 in accordance with an embodiment of the present disclosure. In this example, an extended range (ER) source 1302 may be required to communicate with a non-ER destination 1304. To facilitate such communication between the ER source 1302 and the non-ER destination 1304, a transmission channel between the two devices may be reserved. When the transmission channel is reserved for the ER source 1302 and the non-ER destination 1304, other devices within range may perceive the transmission channel as unavailable for use.

In the fifth channel reservation scheme 1300, the ER source transmits an extended range Request-to-Send (ER-RTS) frame 1310 to non-ER destination 1304, followed by a Request-to-Send (RTS) frame 1312. Each of the RTS frame 1310 and the ER-RTS frame 1312 contains a source address, a destination address, and a transaction duration. The transaction duration may indicate, for example, a time required for completion of the all of the related transactions between the ER source 1302 and the non-ER destination 1304. In the illustrated example, a non-ER OBSS device 1308 detects the RTS frame 1312 and updates a corresponding NAV (RTS) 1324 to reflect the transaction duration indicated by the RTS frame 1312, and an ER OBSS device 1306 detects the ER-RTS frame 1310 and sets or updates a corresponding NAV (ER-RTS) 1326 to reflect the transaction duration indicated by the ER-RTS frame 1310. In response to the RTS frame 1312, the non-ER destination 1304 is configured to transmit a Clear-to-Send (CTS) frame 1314. The CTS frame 1314 may include the address of the ER source 1302 and a transaction duration based on the RTS frame duration (e.g., such that it covers the reservation as per the RTS duration). In this example, the ER OBSS device 1306 and non-ER OBSS device 1308 (e.g., devices in vicinity of the ER source 1302) detect the CTS frame 1314 and update respective NAV timers NAV (CTS) 1330 and NAV (CTS) 1328.

Upon receiving the CTS frame 1312 from the non-ER destination 1304, the ER source 1302 may determine that the transmission channel is reserved and transmit an ER PPDU to the non-ER destination 1304 in ‘n+1’ fragments 1316-0, . . . , 1316-n, where n is a positive integer. Based on the reception of each of the n+1 fragments of the ER-PPDU frame, the non-ER destination 1304 may be configured to transmit ‘n+1’ acknowledgements (ACKs) 1318-0, . . . , 1318-n (also referred to as ACK0) for the n+1 fragments of the ER-PPDU frame. For example, based on receiving an ER-PPDU fragment 1, ACK1 is transmitted by the non-ER destination 1304. In the illustrated example, the ER OBSS device 1306 is further configured to update NAV (ER-fragment i) 1332 corresponding to channel reservation based on the duration indicated in ER-PPDU (fragment i), which may include an ACK duration. In addition, the ER OBSS device 1306 and the non-ER OBSS device 1308 are further configured to update a respective NAV (ACK i) 1334 and NAV (ACK i) 1336 corresponding to channel reservation based on the duration indicated by each ACK i 1318. In this example, the ER source 1302 is further configured to transmit a CTS frame 1320 (e.g., a CTS-to-self frame) following receipt of an ACK. In response, the non-ER OBSS device 1308 updates a NAV (CTS) 1338.

In a further example, the ER source 1302 may not receive the CTS frame 1314 or an ACK 1318. In such a scenario, the ER source 1302 may be configured to wait for a time duration (e.g., short inter-frame spacing (SIFS)*2+ACK/CTS+slot time) and then transmit a contention-free end (CF-END) frame or ER-CF-END frame to the non-ER destination 1304 in order to release the transmission channel. In another example, the non-ER destination 1304 may not receive an ER-PPDU fragment for a pre-defined time duration or may receive a CF-END frame from the ER source 1302. In such a scenario, the non-ER destination 1304 may transmit a CF-END frame to the ER source 1302. In a further example, the ordering of the CF-END frames is reversed.

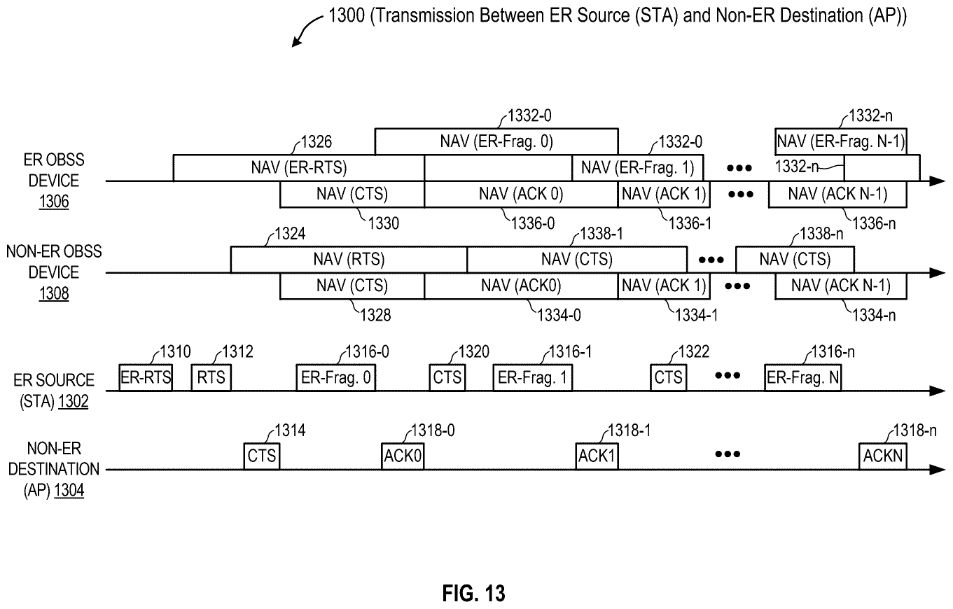

FIG. 14 illustrates a table 1400 presenting a stepwise summarization of the fifth channel reservation scheme 1300 in accordance with an embodiment of the present disclosure. More particularly, the table 1400 illustrates: (1) a transmitted packet/frame and the device transmitting the packet (e.g., ER source, non-ER source, ER destination or non-ER destination); (2) the function of the transmitted packet (e.g., channel reservations); and (3) a channel reservation duration based on each packet for the fifth channel reservation scheme 1300 described above with reference to FIG. 13. Each row of the table corresponds to one step.

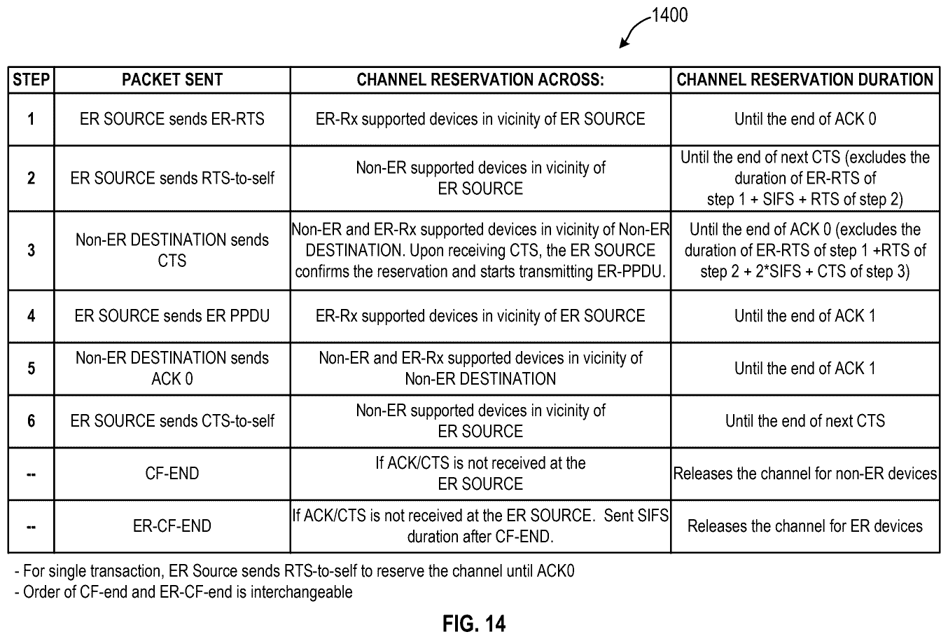

FIG. 15 illustrates a table 1500 presenting a stepwise summarization of a variation of the fifth channel reservation scheme 1300 in accordance with an embodiment of the present disclosure. More particularly, the table 1500 illustrates: (1) a transmitted packet/frame and the device transmitting the packet (e.g., ER source, non-ER source, ER destination or non-ER destination); (2) the function of the transmitted packet (e.g., channel reservations); and (3) a channel reservation duration based on each packet for the fifth channel reservation scheme 1300 described above with reference to FIG. 13, with the exception that in this variation the ER source 1302 does not transmit a CTS-to-self frame after transmitting an ER fragment. Each row of the table corresponds to one step.

FIG. 16 illustrates a sixth channel reservation scheme 1600 in accordance with an embodiment of the present disclosure. In this example, an extended range (ER) source 1602 may be required to communicate with a non-ER destination 1604. To facilitate such communication between the ER source 1602 and the non-ER destination 1604, a transmission channel between the two devices may be reserved. When the transmission channel is reserved for the ER source 1602 and the non-ER destination 1604, other devices within range may perceive the transmission channel as unavailable for use.

In the sixth channel reservation scheme 1600, the ER source transmits an extended range Request-to-Send (ER-RTS) frame 1610 to non-ER destination 1604, and then utilizes simultaneous CTS frames for extending the channel reservation in the non-ER OBSS device(s) 1608. In particular, the ER source transmits a CTS-to-self frame 1612 at the same time the non-ER destination 1604 transmits a CTS frame 1614. Each of the RTS frame 1610, CTS-to-self frame 1612 and the CTS frame 1614 contains a source address, a destination address, and a transaction duration. The transaction duration may indicate, for example, a time required for completion of the all of the remaining transactions between the ER source 1602 and the non-ER destination 1604. In the illustrated example, a non-ER OBSS device 1608 detects the ER-RTS frame 1610 and updates a corresponding NAV (ER-CTS) 1624 to reflect the transaction duration indicated by the ER-RTS frame 1610, and an ER OBSS device 1606 detects the ER-RTS frame 1610 and sets or updates a corresponding NAV (ER-RTS) 1626 to reflect the transaction duration indicated by the ER-RTS frame 1610. The CTS frame 1614 may include the address of the ER source 1602 and a transaction duration based on the RTS frame duration (e.g., such that it covers the reservation as per the RTS duration). In this example, the ER OBSS device 1606 and non-ER OBSS device 1608 (e.g., devices in vicinity of the ER source 1602) detect the CTS-to-self frame 1612 and/or CTS frame 1614 and update respective NAV timers NAV (CTS) 1630 and NAV (CTS) 1628.

Upon receiving the CTS frame 1612 from the non-ER destination 1604, the ER source 1602 may determine that the transmission channel is reserved and transmit an ER PPDU to the non-ER destination 1604 in ‘n+1’ fragments 1616-0, . . . , 1616-n, where n is a positive integer. Based on the reception of each of the n+1 fragments of the ER-PPDU frame, the non-ER destination 1604 may be configured to transmit ‘n+1’ acknowledgements (ACKs) 1618-0, . . . , 1618-n (also referred to as ACK0) for the n+1 fragments of the ER-PPDU frame. For example, based on receiving an ER-PPDU fragment 1, ACK1 is transmitted by the non-ER destination 1604. In the illustrated example, the ER OBSS device 1606 is further configured to update NAV (ER-fragment i) 1632 corresponding to channel reservation based on the duration indicated in ER-PPDU (fragment i), which may include an ACK duration. In addition, the ER OBSS device 1606 and the non-ER OBSS device 1608 are further configured to update a respective NAV (ACK i) 1634 and NAV (ACK i) 1636 corresponding to channel reservation based on the duration indicated by each ACK i 1618. In this example, the ER source 1602 is further configured to transmit a CTS frame 1620 (e.g., a CTS-to-self frame) following receipt of an ACK. In response, the non-ER OBSS device 1608 updates a NAV (CTS) 1638.

In a further example, the ER source 1602 may not receive the CTS frame 1614 or an ACK 1618. In such a scenario, the ER source 1602 may be configured to wait for a time duration (e.g., short inter-frame spacing (SIFS)*2+ACK/CTS+slot time) and then transmit a contention-free end (CF-END) frame or ER-CF-END frame to the non-ER destination 1604 in order to release the transmission channel. In another example, the non-ER destination 1604 may not receive an ER-PPDU fragment for a pre-defined time duration or may receive a CF-END frame from the ER source 1602. In such a scenario, the non-ER destination 1604 may transmit a CF-END frame to the ER source 1602. In a further example, the ordering of the CF-END frames is reversed.

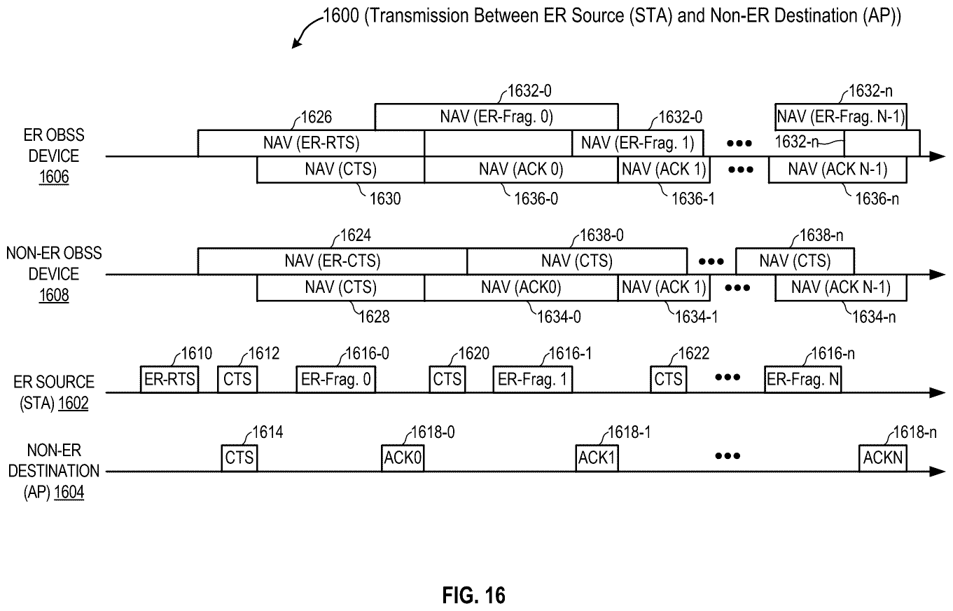

FIG. 17 illustrates a table 1700 presenting a stepwise summarization of the sixth channel reservation scheme in accordance with an embodiment of the present disclosure. More particularly, the table 1700 illustrates: (1) a transmitted packet/frame and the device transmitting the packet (e.g., ER source, non-ER source, ER destination or non-ER destination); (2) the function of the transmitted packet (e.g., channel reservations); and (3) a channel reservation duration based on each packet for the sixth channel reservation scheme 1600 described above with reference to FIG. 16. Each row of the table corresponds to one step.

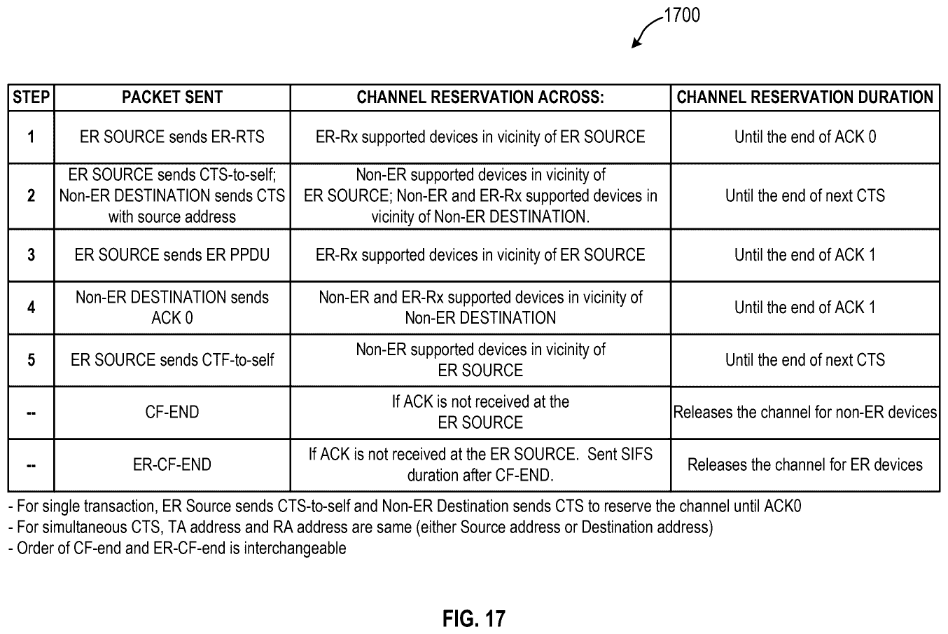

FIG. 18 illustrates a table 1800 presenting a stepwise summarization of a variation of the sixth channel reservation scheme 1600 in accordance with an embodiment of the present disclosure. More particularly, the table 1800 illustrates: (1) a transmitted packet/frame and the device transmitting the packet (e.g., ER source, non-ER source, ER destination or non-ER destination); (2) the function of the transmitted packet (e.g., channel reservations); and (3) a channel reservation duration based on each packet for the sixth channel reservation scheme 1600 described above with reference to FIG. 16, with the exception that in this variation the ER source 1602 does not transmit a CTS-to-self frame after transmitting an ER fragment. Each row of the table corresponds to one step.

The scope of the present disclosure is not limited to a single ER destination or a single non-ER destination. In the various channel reservation schemes described herein, multiple ER destinations may be present. In such scenarios, simultaneous CTS frames or ER-CTS frames are transmitted to/from all ER destinations (e.g., when a source transmits a (extended) multi-user RTS (MU-RTS) frame. In an example, a when CTS frame is transmitted individually, either all ER destinations transmit a CTS/ER-CTS frame simultaneously or each ER destination transmits CTS/ER-CTS frames sequentially with each CTS/ER-CTS frame separated by a SIFS duration. When the ER source receives at least one ER-CTS frame for ER transmission reservation or a CTS frame for non-ER transmission, the ER source may not send the CF-end frame and ER-CF-end frame and continue the ER transmission. The CF-end frame and the ER-CF-end frame may be sent only when none of the ER-CTS/CTS frames are received.

For simultaneous transmission of CTS or ER-CTS frames (e.g., in response to a MU-RTS frame), frame content may be the same and the destination may perform pre-compensation for carrier frequency offset and symbol clock error while transmitting the simultaneous CTS or ER-CTS frames. In some examples, the pre-compensation uses the value from the previously received ER-RTS frame, and if no ER-RTS frame was transmitted from the source then the pre-compensation uses the values from a previously received RTS frame.

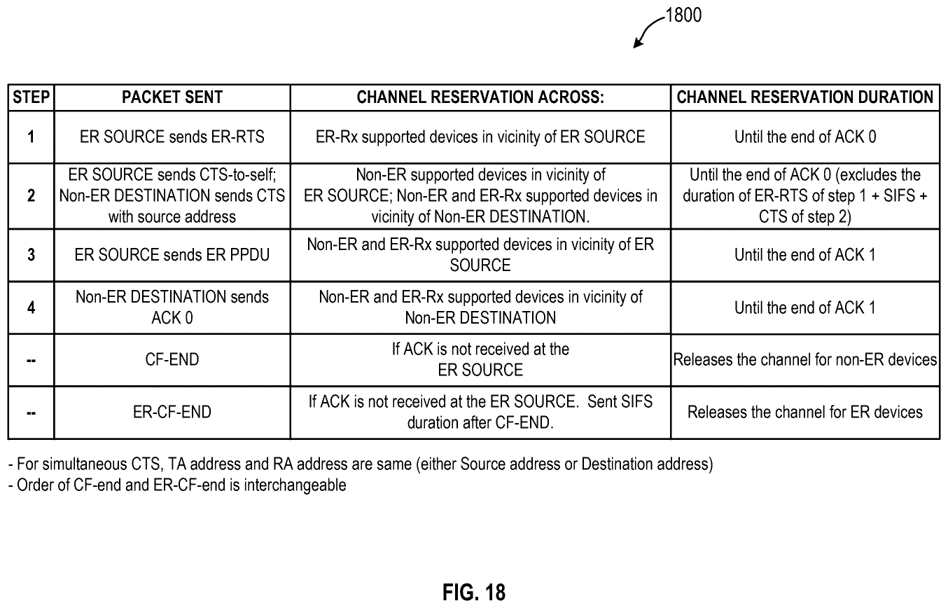

FIG. 19 is a flow diagram illustrating an example method 1900 for channel reservation in accordance with an embodiment of the present disclosure. The method 1900 can be performed, for example, by the AP 102 or STA 116 described with reference to FIG. 1. The method 1900 may be utilized, for example, by an ER source to perform channel reservation operations such as described with reference to any of FIG. 3, FIG. 7, FIG. 13, or FIG. 16.

The method begins at step 1902 where an ER source transmits an extended range (ER) Request to Send (RTS) frame (e.g., for reception by a non-ER wireless device/destination) over a transmission channel. The method continues at step 1904, where the ER source receives a non-ER Clear to Send (CTS) frame in response to the ER RTS frame. Following receipt of the non-ER CTS frame, the method continues at step 1906 where the ER source transmits an ER PPDU (or a fragment of the ER PPDU) to the non-ER wireless device. In response, the ER source receives (at step 1908) a non-ER ACK from the non-ER wireless device. In this manner, OBSS wireless devices (e.g., ER OBSS devices and/or non-ER devices) within range of the illustrated frame exchange (or portions thereof) may update their respective NAV timers to indicate that the transmission channel is busy during the transmission of the ER PPDU, thereby mitigating the possibility of potential frame collisions in the transmission channel.

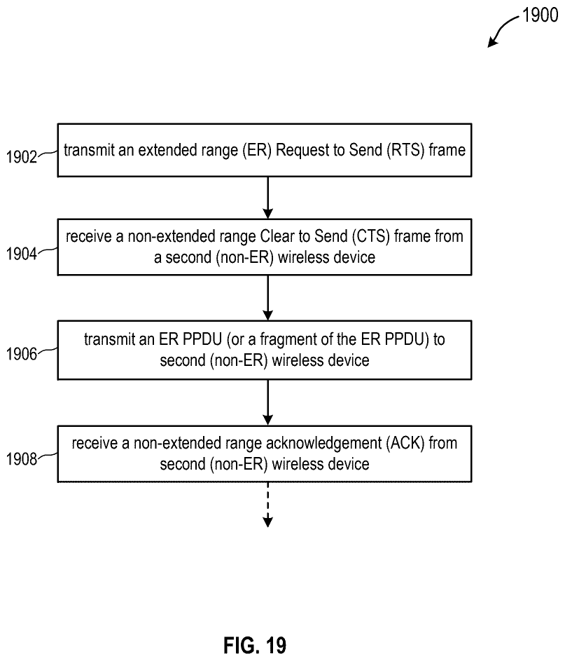

FIG. 20 is a flow diagram illustrating another example method 2000 for channel reservation in accordance with an embodiment of the present disclosure. The method 2000 can be performed, for example, by the AP 102 or STA 116 described with reference to FIG. 1. The method 2000 may be utilized, for example, by a non-ER source to perform channel reservation operations such as described with reference to FIG. 5 and FIG. 10.

The method begins at step 2002 where a non-ER source transmits a non-ER RTS frame (e.g., for reception by an ER wireless device/destination) over a transmission channel. The method continues at step 2004, where the non-ER source receives an ER CTS frame in response to the non-ER RTS frame. Following receipt of the ER CTS frame, the method continues at step 2006 where the non-ER source transmits a non-ER PPDU (or a fragment of the non-ER PPDU) to the ER wireless device. In response, the non-ER source receives (at step 2008) an ER ACK from the ER wireless device. In this manner, OBSS wireless devices (e.g., ER OBSS devices and/or non-ER devices) within range of the illustrated frame exchange (or portions thereof) may update their respective NAV timers to indicate that the transmission channel is busy during the transmission of the non-ER PPDU, thereby mitigating the possibility of potential frame collisions in the transmission channel.

FIG. 21 illustrates an example of an Extended Range (ER)/Enhanced Long Range (ELR) physical layer protocol data unit (PPDU) 2100 that may be utilized in the examples described herein. The ER/ELR PPDU of this example includes a legacy preamble 2102, an ER/ELR preamble 2104, and ER/ELR data 2106. In an example, the ER/ELR PPDU 2100 is legacy ER/ELR PPDU. In another example, such as described in greater detail with reference to FIG. 22, the ER/ELR PPDU 2100 is non-legacy ELR PPDU.

FIG. 22 illustrates an example of an Enhanced Long Range (ELR) physical layer protocol data unit (PPDU) 2200. The ELR PPDU 2200 of this example includes a legacy portion 2202 and an ELR portion 2216, which are transmitted as a waveform. The legacy portion 2202 includes legacy fields which legacy 802.11 devices are able to decode for co-existence while the ELR portion 2216 may include one or more ELR fields so that next generation devices (e.g., Wi-Fi 8 UHR devices) are able to transmit and receive data in the ELR portion 2216 with increased range and lower SNR. In an example, a bandwidth of the legacy portion 2202 and the ELR portion 2216 is the same to provide co-existence with legacy devices.

The legacy portion 2202 of this example includes a legacy short training field (L-STF) 2204, a legacy long training field (L-LTF) 2206, a legacy signal (L-SIG) field 2208, a repeated L-SIG (RL-SIG) field 2210, and a universal signaling (U-SIG) field 2212. The L-STF 2204 is used by a recipient device to detect the start of the PPDU or portion thereof and to establish orthogonal frequency division multiplexed/access (OFDM/A) symbol timing for data detection, i.e. frame acquisition and time synchronization. The L-LTF 2206 is used for channel estimation/training for information detection. Channel estimation is a process of determining channel characteristics (e.g., a frequency response) of a channel in which the PPDU is transmitted. The L-SIG field 2208 includes information for data decoding and coexistence such as a 12 bit packet length value (LENGTH), rate information, etc. In an example, LENGTH is signaled to spoof legacy devices for purposes of clear channel assessment (CCA), and non-legacy devices can decode a TXOP for CCA. In addition, a non-legacy device (e.g., an intended receiver) may also derive a Nsym (with may also be referred to as Length) value from the L_SIG field 2208. However, as L-SIG LENGTH decoding may not be reliable, this information may be repeated in the ELR-SIG field 2222. In an example, a number of data symbols (Nsym/Length) subfield can be directly signaled in the ELR-SIG field 2222 utilizing fewer than 12 bits (e.g., 8 or 9 bits), thereby saving 3-4 bits of signaling and simplifying packet length calculations by receiving devices.

In an example, the L-SIG 2208 may be repeated in time and the repetition is included in the repeated RL-SIG field 2210 of the legacy portion 2202 such that the L-SIG 2208 is repeated twice. The repetition may allow increased range and SNR associated with receipt of the L-SIG field 2208. The U-SIG field 2212 in the legacy portion 2202 may include an indication of a version of the physical layer communication of IEEE 802.11 such as in a three-bit PHY identifier, an uplink/downlink flag, Basic Service Set (BSS) color, transmission (TX) opportunity (TXOP) duration, bandwidth, etc. Like the L-SIG field, the U-SIG field 2212 may also be repeated twice in time for better reception. In the illustrated ELR PPDU, the U-SIG field 2212 includes a U-SIG-1 subfield 2226 and a U-SIG-2 subfield 2228. To also extend the range, a transmission power of a waveform of one or more of the L-STF 2204 and the L-LTF 2206 may be boosted to 3 dB.

To further extended the range, a transmission power associated with the L-STF 2204 and L-LTF 2206 could be boosted to greater than 3 dB and the L-SIG field 2208 and the U-SIG field 2212 may be repeated more than twice, but these changes may create compatibility issues with legacy devices because of energy drop-off between when the legacy device receives the L-SIG 2208 and receives the L-LTF 2206, erroneous detection of the L-SIG field 2208 and U-SIG field 2212, and a high peak to average power ratio of the PPDU. The legacy portion 2202 may be modulated on an orthogonal frequency division multiplexed (OFDM) signal which defines subcarriers for transmitting the fields of the legacy portion 2202 and as a result range extension is also limited by a maximum peak to average ratio (PAPR) of the waveform representing the PPDU which IEEE 802.11 specifies. IEEE 802.11b defines a single-carrier binary sequence design which demonstrates range extension benefits over OFDM associated with 802.11ax and 802.11bc. However, the carrier is only defined for a 2.4 GHz band and does not co-exist with IEEE 802.11a such that the format cannot be extended into a 5 GHZ and 6 GHz band without also causing backward compatibility issues for legacy devices.

In some examples, one or more transition symbols may be optionally added after the U-SIG field 2212 in the legacy portion 2202 preceding the ELR portion 2216. In the illustrated example, an ELR-MARK field 2214 is included. The ELR-MARK field 2214 may be a symbol, such as an OFDM symbol, which spans a channel bandwidth and has a predefined duration, and may signal a transition between the U-SIG field 2212 and the ELR portion 2216. In an example, a non-legacy wireless device receiving the ELR PPDU 2200 may need to determine a receiver state machine based on a U-SIG decoding CRC check. In the event that the U-SIG decoding fails, e.g., a CRC check does not pass, the wireless device needs to reset receive time domain parameters, such as CFO and sample frequency offset (SFO) compensation, while ELR preamble detection logic is still running. The ELR-MARK field 2214 may provide some buffer time such that the ELR preamble will not arrive before the receive time domain parameters is reset. Thus, the ELR preamble detection will not be affected by the status of the legacy preamble detection. In one example, the ELR-MARK field 2214 is defined as a signaling field (with predefined tone patterns), similar to EHT-SIG as in IEEE 802.11bc. In another example, the ELR-MARK field 2214 is a predefined sequence, which can further include a BSS color indication (e.g., a value of 0 to 63) for use by receiving devices to determine if the received PPDU is an ELR PPDU and if the ELR PPDU is from OBSS.

To achieve range extension, the legacy portion 2202 is followed by the ELR portion 2216. By appending the legacy portion 2202 to the ELR portion 2216, the ELR PPDU 2200 is able to co-exist with the 802.11 legacy devices. In an example, a PPDU length in octets indicated in the L-SIG field 2208 is backward compatible with legacy devices to detect the ELR PPDU 2200 while the U-SIG field 2212 provides both backward and forward compatibility. For example, the U-SIG field 2212 is modulated with binary phase shift keying (BPSK), and the U-SIG field 2212 may indicate a “PHY version identifier” which indicates a PHY version. To signal the new ELR format, a new value of “PHY version identifier” in the U-SIG field 2212 can be used to indicate next generation PHY and a new “PPDU format” subfield can indicate the new ELR format. In an example, the ELR PPDU 2200 may be limited for transmission over one spatial stream using modulation coding scheme (MCS) 0 or lower data rates. In an example, an unintended receiver which does not support a non-legacy standard can use indications of these fields to enter into a power save state when the ELR PPDU 2200 is received and is not able to be processed, and set network allocation vector (NAV) values correspondingly to not transmit for at least a PPDU duration.

The ELR portion 2216 of the illustrated example includes an ELR preamble and a UHR-Data field 2224. The ELR preamble includes a UHR short training field (UHR-STF) 2218, a UHR long training field (UHR-LTF) 2220, and an ELR signal (ELR-SIG) field 2222. The UHR-STF 2218 may be a predefined binary sequence used to detect the start of the ELR portion 2216 and provide symbol timing for data detection, i.e. frame acquisition and time synchronization. In one embodiment, the UHR-STF 2218 consists of two parts: one binary sequence for synchronization followed by one binary sequence for STF ending and UHR-LTF 2220 may not be included. In another embodiment, the UHR-STF 2218 consists of one binary sequence followed by UHR-LTF 2220. If the receiver is not able to detect the legacy STF 2204, the receiver will attempt to detect the UHR-STF 2218. The UHR-LTF 2220 defines a binary sequence for channel estimation/training by a receiver. In some examples, this field may be omitted for certain modulation schemes such as differential encoding for 802.11b.

The ELR-SIG field 2222 includes information for data decoding. The ELR-SIG field 2222 may include various parameters including a modulation and coding scheme (MCS) subfield, a coding subfield that indicates whether BCC or LDPC is used, a number of symbols (Nsym) or Length subfield that indicates a number of ELR data symbols, a cyclic redundancy check (CRC), etc., defined by an ELR-SIG binary sequence. In an example, the ELR-SIG field 2222 includes two symbols (i.e., an ELR-SIG-1 subfield 2230 and an ELR-SIG-2 subfield 2232). Forward error correction (FEC) coding may be defined for the ELR-SIG field 2222 to enhance reliability, e.g. binary convolutional coding (BCC). The UHR-Data field 2224 which follows the ELR preamble includes a data payload defined by an ELR-data binary sequence. Forward error correction (FEC) coding may be defined to enhance data decoding reliability, e.g. BCC or low density parity check code (LDPC).

The ELR portion 2216 may be transmitted in various ways. In one example, a waveform representative of the binary sequences of the ELR portion 2216 may be defined with a low peak-to-average ratio (PAPR) such that the transmitter can increase the maximum transmit power to increase communication range or enhance receiver reception reliability. Because the legacy preamble 2202 may already have a high PAPR, a power amplifier associated with the transceiver which transmits the ELR portion 2216 may back off by ˜10 dB to keep all samples which are to be transmitted in a linear region to accommodate the PAPR. The power amplifier may transmit the ELR portion 2216 with some peak samples into a non-linear region for range extension and an ER spectrum growth due to the non-linearity may result in a lower PAPR, close to 0 dB depending on binary sequence design. In an example, the ELR portion 2216 may be transmitted with a power similar to a peak power of the legacy portion 2202 with 10 dB gain, but in some cases, an increase in transmit power may be limited by a power spectral density. In another example, the transmit power of a waveform of the ELR portion 2216 may be set to a power boost such as 3 dB or the transmitter may set a power boost based on a historical transmit power range.

The binary sequence of the UHR-STF 2218 may be modulated on a time domain waveform. Time domain modulation is defined as varying a modulation of a waveform over time. The binary sequence of the UHR-LTF 2220, ELR-SIG 2222, and UHR-Data field 2224 may be transmitted based on single carrier (SC) time-domain multiplexing (TDM). A binary sequence may be directly modulated on a time domain waveform to generate different time domain signals for different binary sequences and additional spreading can be applied, e.g. 802.11b direct sequence spread spectrum (DSSS).

In another example, the modulation of one or more of the fields in the ELR preamble may be based on a single carrier (SC) frequency-domain multiplexing (FDM). Frequency domain multiplexing is defined as loading binary sequences to be transmitted onto subcarriers in a frequency band versus time domain signals, where different frequency bands may be assigned to different wireless devices. The UHR-STF 2218 may be transmitted with one of the 802.11b DSSS, a zero correlation zone (ZCZ) spreading sequence, or a Golay sequence (defined in 802.11ad/ay). The UHR-LTF 2220 may include a predefined binary sequence to estimate a channel of each subcarrier and transmitted in a manner similar to the UHR-STF 2218. The ELR-SIG field 2222 and the UHR-Data field 2224 may be transmitted with SC-FDM. An LTF1 subfield of UHR-LTF 2220 may be added before the ELR-SIG field 2222 to indicate information to demodulate SIG content and an LTF2 subfield of the UHR-LTF 2220 may be added to indicate information to demodulate UHR-Data field 2224 content. The information may indicate a tone mapping and the LTF2 may be included in the UHR-LTF 2220 when a tone mapping of the subcarriers on which a binary sequence of the information are loaded and/or a bandwidth of the UHR-Data field 2224 is different from the ELR-SIG field 2222. The tone mapping may be a process of selecting subcarriers in a set of subcarriers to transmit the binary sequence, where a subcarrier or tone is a defined frequency or frequencies in a channel bandwidth such as a 20 MHz channel having an amplitude and a phase. In an example, a bit or bits of the sequence may be modulated on the tone such as by binary phase shift keying (BPSK) or quadrature phase shift keying (QPSK) to form a waveform.

In the example of FIG. 22, the ELR preamble may have a fixed transmission format as the ELR-SIG field 2222 follows the UHR-STF 2218 and UHR-LTF 2220. For example, the UHR-LTF 2220 transmission format may be fixed at 4xLTF with 4 repetitions, 1xLTF with 16 repetitions, 4xLTF with sparse tone loading and 2 repetitions, etc.

While the innovate aspects of the present disclosure have been generally described in the context of the 802.11bn amendment (and future generations) of the IEEE 802.11 standard, a person having ordinary skill in the art will readily recognize that teachings and concepts herein may be applied to other wireless networks and standards including, for example, Long Term Evolution (LTE) standards and Bluetooth standards.

The innovative channel reservations schemes illustrated in the drawings and described herein minimize potential frame collisions and interference in wireless networks involving devices having disparate transmission ranges. In an illustrative, non-limiting embodiment, a method is provided for reserving a transmission channel by a first wireless device. The method includes transmitting an extended range Request to Send (RTS) frame and receiving, in response, a non-extended range Clear to Send (CTS) frame from a second wireless device. The method further includes transmitting an extended range physical layer protocol data unit (PPDU) for reception by the second wireless device.

The method of this embodiment includes optional aspects. With one optional aspect, transmitting the extended range PPDU includes fragmenting the extended range PPDU into a plurality of extended range fragments and transmitting a first extended range fragment of the plurality of extended range fragments. This optional aspect further includes receiving a non-extended range acknowledgement (ACK) from the second wireless device and transmitting a second extended range fragment of the plurality of extended range fragments. In another optional aspect, in response to detecting a failure to receive at least one of the non-extended range CTS frame or the non-extended range ACK from the second wireless device, the first wireless device transmits a contention-free end (CF-END) frame for reception by the second wireless device. In yet another optional aspect, the first wireless device transmits a non-extended range RTS frame prior to transmitting the second extended range fragment. In yet another optional aspect, the first wireless device transmits a non-extended range CTS frame (e.g., a CTS-to-self frame) prior to transmitting the second extended range fragment.

In another optional aspect, transmitting the extended range PPDU for reception by the second wireless device includes transmitting the extended range PPDU for reception by a plurality of wireless devices that includes the second wireless device. In this optional aspect, the method further includes sequentially receiving a non-extended range acknowledgement (ACK) from at least two of the plurality of wireless devices (separated by a Short Interframe Spacing (SIFS)) in response to transmitting the extended range PPDU, and further transmitting a second extended range PPDU for reception by the plurality of wireless devices. In yet another optional aspect, the extended range RTS frame is a multi-user RTS (MU-RTS) frame and transmitting the extended range PPDU further includes transmitting the extended range PPDU for reception by a plurality of wireless devices that includes the second wireless device. This optional aspect further includes simultaneously receiving a non-extended range acknowledgement (ACK) from at least two of the plurality of wireless devices and transmitting a second extended range PPDU for reception by the plurality of wireless devices.

In another illustrative, non-limiting embodiment, a method is provided for reserving a transmission channel by a first wireless device. The method of this embodiment includes transmitting a non-extended range Request to Send (RTS) frame and receiving, in response, an extended range Clear to Send (CTS) frame from a second wireless device. The method further includes transmitting a non-extended range physical layer protocol data unit (PPDU) for reception by the second wireless device.

The method of this embodiment includes optional aspects. With one optional aspect, transmitting the non-extended range PPDU includes fragmenting the non-extended range PPDU into a plurality of extended range fragments and transmitting a first non-extended range fragment of the plurality of extended range fragments. This optional aspect further includes receiving an extended range acknowledgement (ACK) from the second wireless device and transmitting a second non-extended range fragment of the plurality of extended range fragments. In another optional aspect, in response to detecting a failure to receive at least one of the extended range CTS frame or the extended range ACK from the second wireless device, the first wireless device transmits a contention-free end (CF-END) frame for reception by the second wireless device. In yet another optional aspect, the first wireless device receives a non-extended range CTS frame from the second wireless device prior to transmitting the non-extended range PPDU.

In another optional aspect, transmitting the non-extended range PPDU for reception by the second wireless device includes transmitting the non-extended range PPDU for reception by a plurality of wireless devices that includes the second wireless device. In this optional aspect, the method further includes sequentially receiving an extended range acknowledgement (ACK) from at least two of the plurality of wireless devices (separated by a Short Interframe Spacing (SIFS)) in response to transmitting the non-extended range PPDU, and further transmitting a second non-extended range PPDU for reception by the plurality of wireless devices. In yet another optional aspect, the non-extended range RTS frame is a multi-user RTS (MU-RTS) frame and transmitting the non-extended range PPDU further includes transmitting the non-extended range PPDU for reception by a plurality of wireless devices that includes the second wireless device. This optional aspect further includes simultaneously receiving a non-extended range acknowledgement (ACK) from at least two of the plurality of wireless devices and transmitting a second non-extended range PPDU for reception by the plurality of wireless devices.

With another illustrative, non-limiting embodiment, a wireless device includes one or more wireless transceivers and one or more processors operably coupled to the one or more wireless transceivers. The one or more processors are arranged to execute the operational instructions to transmit an extended range Request to Send (RTS) frame and receive, in response, a non-extended range Clear to Send (CTS) frame from a second wireless device. The one or more processors of the wireless device are further arranged to transmit an extended range physical layer protocol data unit (PPDU) for reception by the second wireless device.

The embodiment includes optional aspects. With one optional aspect, transmitting the extended range PPDU includes fragmenting the extended range PPDU into a plurality of extended range fragments and transmitting a first extended range fragment of the plurality of extended range fragments. In this optional aspect, the one or more processors of the wireless device are further arranged to receive a non-extended range acknowledgement (ACK) from the second wireless device and transmit a second extended range fragment of the plurality of extended range fragments. In another optional aspect, the first wireless device transmits a non-extended range RTS frame prior to transmitting the second extended range fragment. In yet another optional aspect, the first wireless device transmits a non-extended range CTS frame (e.g., a CTS-to-self frame) prior to transmitting the second extended range fragment.

In another optional aspect, the extended range RTS frame is a multi-user RTS (MU-RTS) frame and transmitting the extended range PPDU for reception by the second wireless device further includes transmitting the extended range PPDU for reception by a plurality of wireless devices that includes the second wireless device. In this optional aspect, the one or more processors are further arranged to simultaneously receive a non-extended range acknowledgement (ACK) from at least two of the plurality of wireless devices in response to transmitting the extended range PPDU, and transmit a second extended range PPDU for reception by the plurality of wireless devices.

In another illustrative, non-limiting embodiment, a wireless device includes one or more wireless transceivers and one or more processors operably coupled to the one or more wireless transceivers. The one or more processors are arranged to execute the operational instructions to transmit a non-extended range Request to Send (RTS) frame and receive, in response, an extended range Clear to Send (CTS) frame from a second wireless device. The one or more processors of the wireless device are further arranged to transmit a non-extended range physical layer protocol data unit (PPDU) for reception by the second wireless device.

The embodiment includes optional aspects. With one optional aspect, transmitting the non-extended range PPDU includes fragmenting the non-extended range PPDU into a plurality of non-extended range fragments and transmitting a first non-extended range fragment of the plurality of non-extended range fragments. In this optional aspect, the one or more processors of the wireless device are further arranged to receive an extended range acknowledgement (ACK) from the second wireless device and transmit a second non-extended range fragment of the plurality of non-extended range fragments. In another optional aspect, the one or more processors of the wireless device are further arranged to receive an extended range CTS frame from the second wireless device prior to transmitting the non-extended range PPDU.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a processing core, processing circuitry, computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

As may be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may further be used herein, the term(s) “arranged to”, “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with” includes direct and/or indirect coupling of separate items and/or one item being embedded within another item.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processor”, “processing circuitry”. “processing circuit”, “processing module”, and/or “processing unit” may be a single processing device or a plurality of processing devices. Such a processing device may be a microprocessor, microcontroller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. Further, such a processing device may include a plurality of processing cores or processing domains, which may operate on separate power domains. The processor, processing circuitry, processing circuit, processing module, and/or processing unit may be (or may further include) memory and/or an integrated memory element, which may be a single memory device, a plurality of memory devices, and/or embedded circuitry of another processor, processing circuitry, processing circuit, processing module, and/or processing unit. Such a memory device may be a read-only memory, random access memory, volatile memory, non-volatile memory, static memory, dynamic memory, flash memory, cache memory, and/or any device that stores digital information. Note that if the processor, processing circuitry, processing circuit, processing module, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processor, processing circuitry, processing circuit, processing module, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processor, processing circuitry, processing circuit, processing module, and/or processing unit executes, hard coded and/or operational instructions corresponding to at least some of the steps and/or functions illustrated in one or more of the figures. Such a memory device or memory clement can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the logic diagram block boundaries and sequence could have been defined otherwise and still perform the certain significant functionality. Such alternate definitions of both functional building blocks and logic diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors/processing cores executing appropriate software and the like or any combination thereof.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

The term “module” may be used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory clement may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for reserving a transmission channel by a first wireless device, the method comprising:
transmitting an extended range Request to Send (RTS) frame;
receiving, in response to the extended range RTS frame, a non-extended range Clear to Send (CTS) frame from a second wireless device; and
transmitting an extended range physical layer protocol data unit (PPDU) for reception by the second wireless device.

2. The method of claim 1, wherein transmitting the extended range PPDU for reception by the second wireless device includes:
fragmenting the extended range PPDU into a plurality of extended range fragments;
transmitting a first extended range fragment of the plurality of extended range fragments;
receiving a non-extended range acknowledgement (ACK) from the second wireless device; and
transmitting a second extended range fragment of the plurality of extended range fragments.

3. The method of claim 2, further comprising:
in response to detecting a failure to receive at least one of the non-extended range CTS frame or the non-extended range ACK from the second wireless device, transmitting a contention-free end (CF-END) frame for reception by the second wireless device.

4. The method of claim 1, further comprising:
prior to transmitting the extended range PPDU, transmitting a non-extended range RTS frame.

5. The method of claim 1, further comprising:
prior to transmitting the extended range PPDU, transmitting a non-extended range CTS frame.

6. The method of claim 1, wherein transmitting the extended range PPDU for reception by the second wireless device includes transmitting the extended range PPDU for reception by a plurality of wireless devices that includes the second wireless device, the method further including:
in response to transmitting the extended range PPDU, sequentially receiving a non-extended range acknowledgement (ACK) from at least two of the plurality of wireless devices, wherein consecutive ACKs are separated by a Short Interframe Spacing (SIFS); and
transmitting a second extended range PPDU for reception by the plurality of wireless devices.

7. The method of claim 1, wherein the extended range RTS frame is a multi-user RTS (MU-RTS) frame and wherein transmitting the extended range PPDU for reception by the second wireless device further includes transmitting the extended range PPDU for reception by a plurality of wireless devices that includes the second wireless device, the method further including:
in response to transmitting the extended range PPDU, simultaneously receiving a non-extended range acknowledgement (ACK) from at least two of the plurality of wireless devices; and
transmitting a second extended range PPDU for reception by the plurality of wireless devices.

8. A method for reserving a transmission channel by a first wireless device, the method comprising:
transmitting a non-extended range Request to Send (RTS) frame;
receiving, in response to the non-extended range RTS frame, an extended range Clear to Send (CTS) frame from a second wireless device; and
transmitting a non-extended range physical layer protocol data unit (PPDU) for reception by the second wireless device.

9. The method of claim 8, wherein transmitting the non-extended range PPDU for reception by the second wireless device includes:
fragmenting the non-extended range PPDU into a plurality of non-extended range fragments;
transmitting a first non-extended range fragment of the plurality of non-extended range fragments;
receiving an extended range acknowledgement (ACK) from the second wireless device; and
transmitting a second non-extended range fragment of the plurality of non-extended range fragments.

10. The method of claim 9, further comprising:
in response to detecting a failure to receive at least one of the extended range CTS frame or the extended range ACK from the second wireless device, transmitting a contention-free end (CF-END) frame for reception by the second wireless device.

11. The method of claim 8, further comprising:
prior to transmitting the non-extended range PPDU, receiving a non-extended range CTS frame from the second wireless device.

12. The method of claim 8, wherein transmitting the non-extended range PPDU for reception by the second wireless device includes transmitting the non-extended range PPDU for reception by a plurality of wireless devices that includes the second wireless device, the method further comprising:
in response to transmitting the non-extended range PPDU, sequentially receiving an extended range acknowledgement (ACK) from at least two of the plurality of wireless devices, wherein consecutive ACKs are separated by a Short Interframe Spacing (SIFS); and
transmitting a second non-extended range PPDU for reception by the plurality of wireless devices.

13. The method of claim 8, wherein the non-extended range RTS frame is a multi-user RTS (MU-RTS) frame and wherein transmitting the non-extended range PPDU for reception by the second wireless device further includes transmitting the non-extended range PPDU for reception by a plurality of wireless devices that includes the second wireless device, the method further comprising:
in response to transmitting the extended range PPDU, simultaneously receiving an extended range acknowledgement (ACK) from at least two of the plurality of wireless devices; and
transmitting a second non-extended range PPDU for reception by the plurality of wireless devices.

14. A wireless device, comprising:
one or more wireless transceivers; and
one or more processors operably coupled to the one or more wireless transceivers, wherein the one or more processors are arranged to:
transmit an extended range Request to Send (RTS) frame;
receive, in response to the extended range RTS frame, a non-extended range Clear to Send (CTS) frame from a second wireless device; and
transmit an extended range physical layer protocol data unit (PPDU) for reception by the second wireless device.

15. The wireless device of claim 14, wherein transmitting the extended range PPDU for reception by the second wireless device includes:
fragmenting the extended range PPDU into a plurality of extended range fragments;
transmitting a first extended range fragment of the plurality of extended range fragments;
receiving a non-extended range acknowledgement (ACK) from the second wireless device; and
transmitting a second extended range fragment of the plurality of extended range fragments.

16. The wireless device of claim 14, wherein the one or more processors are further arranged to:
prior to transmitting the extended range PPDU, transmit a non-extended range RTS frame.

17. The wireless device of claim 14, wherein the one or more processors are further arranged to:
prior to transmitting the extended range PPDU, transmit a non-extended range CTS frame.

18. The wireless device of claim 14, wherein transmitting the extended range PPDU for reception by the second wireless device includes transmitting the extended range PPDU for reception by a plurality of wireless devices that includes the second wireless device, and wherein the one or more processors are further arranged to:
in response to transmitting the extended range PPDU, sequentially receive a non-extended range acknowledgement (ACK) from at least two of the plurality of wireless devices, wherein consecutive ACKs are separated by a Short Interframe Spacing (SIFS); and
transmit a second extended range PPDU for reception by the plurality of wireless devices.

19. The wireless device of claim 14, wherein the extended range RTS frame is a multi-user RTS (MU-RTS) frame and wherein transmitting the extended range PPDU for reception by the second wireless device further includes transmitting the extended range PPDU for reception by a plurality of wireless devices that includes the second wireless device, the one or more processors are further arranged to:
in response to transmitting the extended range PPDU, simultaneously receive a non-extended range acknowledgement (ACK) from at least two of the plurality of wireless devices; and
transmit a second extended range PPDU for reception by the plurality of wireless devices.

20. A wireless device, comprising:
one or more wireless transceivers; and
one or more processors operably coupled to the one or more wireless transceivers, wherein the one or more processors are arranged to:
transmit a non-extended range Request to Send (RTS) frame;
receive, in response to the non-extended range RTS frame, an extended range Clear to Send (CTS) frame from a second wireless device; and
transmit a non-extended range physical layer protocol data unit (PPDU) for reception by the second wireless device.

21. The wireless device of claim 20, wherein transmitting the non-extended range PPDU for reception by the second wireless device includes:
fragmenting the non-extended range PPDU into a plurality of non-extended range fragments;
transmitting a first non-extended range fragment of the plurality of non-extended range fragments;
receiving an extended range acknowledgement (ACK) from the second wireless device; and
transmitting a second non-extended range fragment of the plurality of non-extended range fragments.

22. The wireless device of claim 20, wherein the one of more processors are further arranged to:
prior to transmitting the non-extended range PPDU, receive an extended range CTS frame from the second wireless device.
